(19) United States
(12) Patent Application Publication
(10) Pub. No.: US 2026/0300447 A1
(43) Pub. Date: Oct. 1, 2026

(54) SYSTEMS AND METHODS FOR CONTENT MANAGEMENT

(71) Applicant: Blockchains Holding Co., Reno, NV (US)

(72) Inventors: Jeffrey Keith Berns, Las Vegas, NV (US); Sinclair Fleming, Northridge, CA (US); Alex Oberhauser, Burlington, MA (US)

(21) Appl. No.: 19/578,036

(22) Filed: Mar. 25, 2026

Related U.S. Application Data
(60) Provisional application No. 63/778,008, filed on Mar. 26, 2025.

(51) Int. Cl. G06F 21/10

(52) U.S. Cl. CPC G06F 21/1065

(57) ABSTRACT

Systems and methods for managing content. In some embodiments, a computer-implemented method is provided for recording content on an electronic ledger. A state of an electronic ledger is embedded into a piece of content, wherein the electronic ledger has recorded thereon a plurality of pieces of content. The piece of content is recorded, with the state of the electronic ledger embedded therein, on the electronic ledger.

### CROSS-REFERENCE TO RELATED APPLICATIONS

This application claims the benefit under 35 U.S.C. § 119 (e) of U.S. Provisional application Ser. No. 63/778,008, filed Mar. 26, 2025, titled, “SYSTEMS AND METHODS FOR CONTENT MANAGEMENT,” the entire contents of which is incorporated by reference herein.

### BACKGROUND

Individual creators have increasingly turned to social media platforms to publish and/or promote content. For instance, a creator may upload a piece of content to a social media platform (e.g., YouTube, X, Instagram, or TikTok), and the platform may use personalization algorithms to push the content selectively to users who are likely to engage with the content.

### SUMMARY

In accordance with some embodiments, a computer-implemented method is provided for recording content on an electronic ledger. The method comprises acts of: embedding a state of an electronic ledger into a piece of content, wherein the electronic ledger has recorded thereon a plurality of pieces of content; and recording the piece of content, with the state of the electronic ledger embedded therein, on the electronic ledger.

In accordance with some embodiments, a system is provided, comprising at least one processor and at least one computer-readable storage medium having stored thereon instructions which, when executed, program the at least one processor to perform any of the methods described herein.

In accordance with some embodiments, at least one computer-readable storage medium is provided, having stored thereon instructions which, when executed, program at least one processor to perform any of the methods described herein.

### BRIEF DESCRIPTION OF DRAWINGS

FIG. 1 shows an illustrative content management platform 100, in accordance with some embodiments.

FIG. 2 shows an illustrative ledger 200, in accordance with some embodiments.

FIG. 3 shows an illustrative tree 300, in accordance with some embodiments.

FIG. 4 shows the illustrative ledger 200 in the example of FIG. 2, in accordance with some embodiments.

FIG. 5 shows an illustrative process 500 for making a piece of content available, in accordance with some embodiments.

FIG. 6 shows an illustrative content registry 600, in accordance with some embodiments.

FIG. 7 shows an illustrative process 700 for discovering and/or licensing content, in accordance with some embodiments.

FIG. 8 shows an illustrative process 800 for managing a license, in accordance with some embodiments.

FIG. 9 shows an illustrative process 900 for transferring a license, in accordance with some embodiments.

FIG. 10 shows an illustrative process 1000 for verification, in accordance with some embodiments.

FIG. 11 shows an illustrative process 1100 for delegation of authority, in accordance with some embodiments.

FIG. 12 shows an illustrative process 1200 for access authorization, in accordance with some embodiments.

FIG. 13 shows an illustrative process 1300 for access control, in accordance with some embodiments.

FIG. 14 shows, schematically, an illustrative computer 10000 on which any aspect of the present disclosure may be implemented.

### DETAILED DESCRIPTION

Aspects of the present disclosure relate to systems and methods for managing content. For instance, one or more of the techniques described herein may be used to manage creation, publication, storage, registration, access, and/or verification of content.

While social media platforms may provide an effective marketing channel, creators may have little protection against unauthorized use of their content. Once a piece of content is uploaded to a social media platform, a creator of the content may have little or no control over who may download the content, or how the content may be used subsequently. A digital pirate may gain access to the content via the social media platform, and may distribute the content without permission from, or accounting to, the creator. This may lead to reputational harm and/or loss of opportunities for the creator.

Some approaches for content protection, such as digital rights management (DRM), focus on controlling access to content. These approaches face significant usability challenges. For instance, many DRM techniques involve online authentication with servers that are susceptible to denial-of-service attacks. Moreover, decryption of protected content may lead to performance degradation. As a result, creators aiming to reach as many content consumers as possible often opt out of this type of protection.

Other approaches for content protection focus on provenance. For instance, provenance metadata may be attached to a piece content to be distributed. Such metadata may identify a creator of the content, and may be secured against tampering. For example, the provenance metadata may include a digital signature generated over the content using a private key associated with a public key certificate of the creator.

The inventors have recognized and appreciated that, while a digital signature generated by a creator may be used to verify that a piece of content has indeed come from the creator, the digital signature, by itself, may not be sufficient to establish authorship. For instance, a digital pirate may replace the creator's digital signature with a digital signature generated using a private key associated with a public key certificate of the pirate. In addition, the pirate may modify other metadata (e.g., a timestamp) so that a content consumer with limited digital forensics expertise may be unable to discern whether the creator or the pirate is the original author.

Accordingly, in some embodiments, information evidencing authorship of a piece of content may be embedded into the content itself (e.g., using a suitable watermarking or steganography technique), before the content is distributed. Additionally, or alternatively, a record for the content may be stored on an electronic ledger associated with a creator of the content. The creator's ledger may be anchored to a main ledger in a suitable manner. The creator's ledger may be public, private, or permissioned (e.g., depending on the creator's preference), and likewise for the main ledger.

In some embodiments, information embedded into a piece of content may include information obtained based on a state of an electronic ledger associated with a creator of the content. This may advantageously provide a form of anchoring for the creator's ledger, in addition to, or instead of, anchoring to a distributed ledger.

Examples of content include, but are not limited to, image, video, audio (e.g., music, talk, etc.), text (e.g., book, article, document, software, etc.), multi-media material (e.g., educational/training material, game, etc.), design (e.g., drawing, model, etc.), etc.

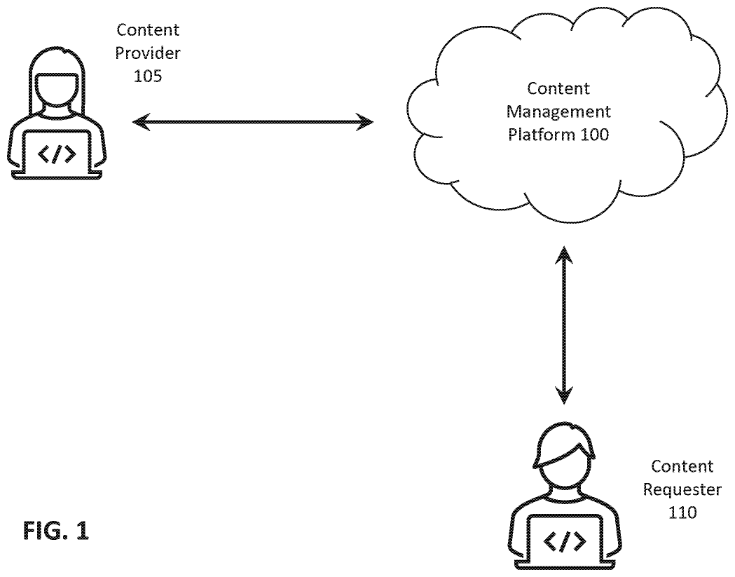

FIG. 1 shows an illustrative content management platform 100, in accordance with some embodiments. The content management platform 100 may allow a content provider 105 to create one or more pieces of content. For instance, the content management platform 100 may provide one or more tools to facilitate creation of content, such as one or more generative artificial intelligence (AI) tools configured to generate content based on natural language input.

Additionally, or alternatively, the content management platform 100 may allow the content provider 105 to publish one or more pieces of content. For instance, the content management platform 100 may provide a content marketplace through which users may list, search for, view, purchase, sell, and/or license content. The content provider 105 may create a listing for a piece of content to be included in a collection of listings maintained by the content management platform 100.

In some embodiments, a listing may include one or more pieces of metadata associated with the content, in addition to, or instead of the content itself. Examples of metadata include, but are not limited to, any suitable information about the content provider 105 (e.g., DID, name, phone number, physical address, email address, social media handle, domain name, etc.), content identifier (CID), title, topic, summary, thumbnail image, text excerpt, audio snippet, video snippet, creator identity, creation date and/or time, uniform resource locator (URL), security information (e.g., to establish authenticity, integrity, etc.), license information, hosting information, reference information, etc.

For instance, the content to which the listing pertains (present content, for short) may be derived from, include, or otherwise be related to one or more portions of another piece of content (referenced content, for short). Accordingly, the listing may include reference information that identifies the referenced content, and/or indicates a relationship between the present content and the referenced content. Additionally, or alternatively, the reference information may identify an author of the referenced content, and/or one or more license terms under which the referenced information is used.

The inventors have recognized and appreciated that reference information in content listings may be used to facilitate compliance with legal and/or contractual requirements, for example, by providing attribution to authors of referenced content. However, it should be appreciated that aspects of the present disclosure are not limited to having any particular reference information in a content listing, or any reference information at all.

In some embodiments, the content management platform 100 may allow the content provider 105 to store one or more pieces of content. For instance, the content provider 105 may use one or more devices (e.g., camera, smartphone, tablet, laptop, desktop, workstation, etc.) to create a piece of content, and may upload the content to the content management platform 100 for storage. The content management platform 100 may implement any suitable storage architecture, such as web-based object storage (e.g., Amazon Simple Storage Service, or S3), InterPlanetary File System (IPFS), peer-to-peer (P2P) file sharing (e.g., BitTorrent), etc.

Additionally, or alternatively, the content management platform 100 may allow the content provider 105 to register one or more pieces of content. For instance, the content management platform 100 may maintain a registry, where each entry in the registry may be associated with one or more pieces of content. As an example, an entry may store information that may be used to prove one or more attributes of a piece of content, such as creator identity, creation date and/or time, creation method (e.g., whether the content is synthetically generated or modified), etc.

Additionally, or alternatively, the content management platform 100 may allow a content requester 110 to access one or more pieces of content. For instance, as described above, the content management platform 100 may maintain a collection of listings. The content management platform 100 may allow the content requester 110 to search the collection of listings (e.g., using an AI assistant configured to receive natural language input). Once the content requester 110 identifies a piece of desired content, the content management platform 100 may provide access to the identified content, and/or instructions for obtaining authorization for such access. As an example, the content management platform 100 may instruct the content requester 110 to submit a payment to a provider of the identified content. As another example, the content management platform 100 may instruct the content requester 110 to attest to one or more requirements (e.g., age, residency, etc.).

Additionally, or alternatively, the content management platform 100 may allow a content requester 110 to verify one or more pieces of content. For instance, as described above, the content management platform 100 may maintain a registry storing information that may be used to prove content attributes. The content requester 110 may look up the registry using an identifier or other information relating to a piece of content. If there is a matching entry, the content requester 110 may use information stored in the entry to verify one or more attributes of the content.

A user (e.g., the content provider 105 or the content requester 110) may interact with the content management platform 100 in any suitable manner. For instance, the user may interact with the content management platform 100 via a web browser running on a user device (e.g., a desktop, a workstation, or a mobile device such as a laptop, a tablet, a smartphone, etc.). The web browser may execute one or more software scripts (e.g., in JavaScript) received from the content management platform 100. Additionally, or alternatively, the user may interact with stand-alone software installed on the user device, where the stand-alone software may be configured to communicate with the content management platform 100 via one or more remote application programming interfaces (APIs).

In some embodiments, one or more functionalities may be distributed in a suitable manner, for instance, among the user device, the content management platform 100, and/or one or more other systems. As an example, software running on the user device (e.g., a web browser executing a script, or stand-alone software) may convert a speech prompt spoken by the user into text, and may transmit such text to the content management platform 100. In response, the content management platform 100 may use the received text to invoke an AI system that is configured to generate and/or search for content.

It should be appreciated that the techniques introduced above and/or described below may be implemented in numerous ways, as these techniques are not limited to any particular manner of implementation. Examples of implementation details are provided herein solely for purposes of illustration. Furthermore, the techniques described herein may be used individually or in any suitable combination, as aspects of the present disclosure are not limited to any particular technique or combination of techniques.

The inventors have recognized and appreciated various challenges associated with unauthorized exploitation of content (e.g., unauthorized copying, sharing, adapting, performing, etc.). For instance, a creator may create a piece of content (e.g., an image), and may upload the content to a social media platform. Another user of the social media platform may, without the creator's authorization, post the content to a different social media platform, create new content based on one or more portions of the original content, etc. The other user may do so without attribution to the creator, or may even claim to have created the content.

In some instances, a device that is used to create a piece of content may be configured to associate the content with appropriate metadata. For instance, a camera may output an image into a file that may include a timestamp indicating when the image was taken, global positioning system (GPS) coordinates indicating where the image was taken, etc. Such metadata may provide some evidence for proving (or disproving) authorship.

However, metadata may be easily scrubbed and/or forged. As such, a creator may not be able to rely on metadata alone to prove authorship of a piece of content.

Accordingly, in some embodiments, techniques are provided for storing, on an electronic ledger, a record relating to one or more pieces of content, thereby providing a reliable proof of authorship. For instance, the electronic ledger may be a distributed ledger maintained by a network of nodes, so that records in the electronic ledger may be immutable as long as at least a threshold number of nodes (e.g., a majority of nodes) correctly follow a certain distributed ledger protocol.

In some embodiments, the distributed ledger may be implemented using a blockchain. The blockchain may include a plurality of blocks, where each block may include a plurality of transactions that are ordered chronologically, or in some other suitable manner. Additionally, or alternatively, each newly added block may be linked to a latest previous block. For instance, the new block may include a cryptographic hash of the previous block. Such a structure may provide tamper resistance, and may therefore be used to confirm whether a given transaction did take place, and/or when that transaction took place relative to one or more other transactions.

In some embodiments, a new block may be added to the blockchain only if all nodes in the network, or a subset of nodes with sufficient computation power, agree on the block. Any suitable distributed consensus technique may be used to reach an agreement. For instance, the fastest node to solve a computationally intensive mathematical puzzle (e.g., identifying a preimage of a hash with a certain number of leading zeros) may be selected to add the next block. Depending on how much computation power is available in the network at a given point in time, a more or less complex mathematical puzzle may be used, so that each new block may be added within a selected window of time.

In this manner, a malicious entity may have to control a large portion (e.g., more than 50%) of the network's computation power to mount a successful attack. To incentivize participation of honest entities, a node may be rewarded with an internal digital asset (e.g., a bitcoin) each time that node is selected to add the next block.

It should be appreciated that aspects of the present disclosure are not limited to using a proof-of-work approach to achieve distributed consensus. Additionally, or alternatively, a proof-of-stake approach may be used, where nodes are selected according to their respective stakes in a cryptocurrency. It should also be appreciated that any suitable blockchain implementation may be used, such as Ethereum, Hyperledger Fabric, etc.

Furthermore, aspects of the present disclosure are not limited to using a blockchain to implement a distributed ledger. In some embodiments, one or more distributed hash tables, directed acyclic graphs (e.g., IOTA Tangle), hashgraphs (e.g., Swirlds), hash trees (e.g., Guardtime keyless signatures infrastructure), and/or distributed ledgers with no globally-shared chain (e.g., R3 Corda), may be used in addition to, or instead of, one or more blockchains.

The inventors have recognized and appreciated that a significant amount of computing resources (e.g., memory, processor cycles, network bandwidth, etc.) may be used to store a record on a distributed ledger. Therefore, a system that stores a record for every piece of content individually on a distributed ledger may not be scalable.

Accordingly, in some embodiments, one or more pieces of content may be recorded on a local ledger, which may be anchored to a distributed ledger. This may conserve computing resources, while providing a desired level of immutability.

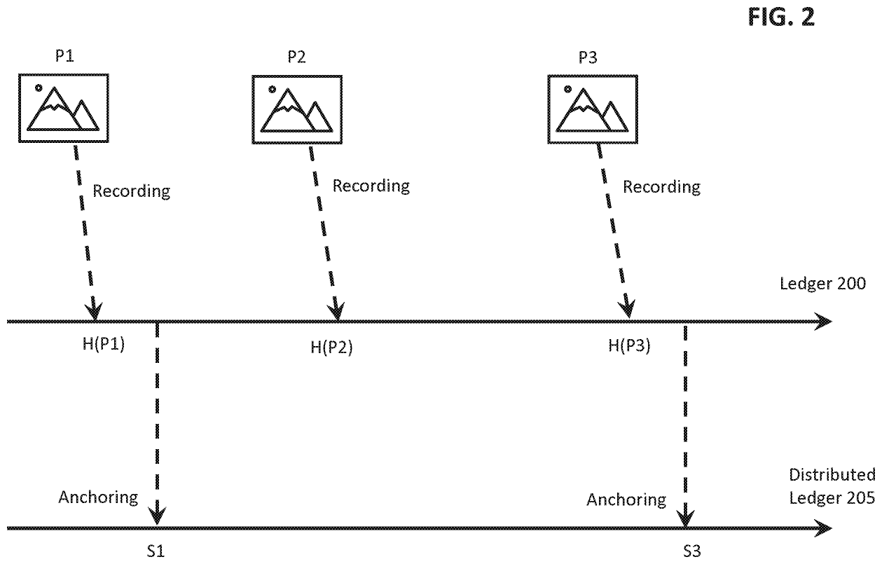

FIG. 2 shows an illustrative ledger 200, in accordance with some embodiments. For instance, the electronic ledger 200 may be maintained by a device of the content provider 105 in the example of FIG. 1.

In some embodiments, the electronic ledger 200 may not be distributed over a large number of nodes. For instance, the electronic ledger 200 may be maintained by just one node, or a small number of nodes (e.g., running on devices of the content provider 105). Such nodes may be connected to the same local area network, and may participate in a suitable distributed ledger protocol over the local area network to synchronize the electronic ledger 200.

Additionally, or alternatively, a backup copy of the electronic ledger 200 may be maintained on a remote device (e.g., a cloud computing server) that does not participate in the distributed ledger protocol.

In some embodiments, a device of the content provider 105 may be configured to record one or more pieces of content on the electronic ledger 200. For instance, upon capturing a new image P1, the content provider 105 may use a software application running on the device to initiate a transaction to record the image P1 on the electronic ledger 200. The recordation transaction may include a cryptographic proof of the image P1, and/or the image P1 itself.

The cryptographic proof of the image P1 may be generated in any suitable manner, for instance, by applying a cryptographic hash function to the image to obtain a hash H(P1).

In the example of FIG. 2, the electronic ledger 200 is anchored to a distributed ledger 205. The distributed ledger 205 may be maintained by a network of nodes, such as one or more nodes operated by the illustrative content management platform 100 in the example of FIG. 1, and/or one or more nodes independent of the content management platform 100. For instance, the distributed ledger 205 may be the Ethereum mainnet, or another Ethereum network. However, it should be appreciated that aspects of the present disclosure are not limited to anchoring the electronic ledger 200 to any particular distributed ledger, or any distributed ledger at all.

The electronic ledger 200 may be implemented in any suitable manner. As one example, the electronic ledger 200 may be built as a layer 2 (L2) ledger (e.g., using Polygon Chain Development Kit, or CDK), and thus the electronic ledger 200 may derive security from a layer 1 (L1) ledger (e.g., the distributed ledger 205). As another example, the electronic ledger 200 may be part of a network of multiple ledgers (e.g., Polkadot parachains, Avalanche subnets, etc.).

In some embodiments, the electronic ledger 200 may be anchored by periodically recording a current state of the electronic ledger 200 on the distributed ledger 205. Such anchoring may take place at any suitable frequency (e.g., every hour, two hours, three hours, four hours, five hours, six hours, . . . ).

The inventors have recognized and appreciated that anchoring more frequently may allow the content provider 105 to prove authorship at a finer time scale. However, anchoring more frequently may also increase consumption of computer resources (e.g., memory, processor cycles, network bandwidth, etc.). Accordingly, in some embodiments, an anchoring frequency may be chosen to achieve a desired balance between strength of authorship proofs and conservation of computing resources.

It should be appreciated that aspects of the present disclosure are not limited to anchoring the electronic ledger 200 at regular intervals. In some embodiments, the electronic ledger 200 may be anchored at irregular intervals. Additionally, or alternatively, the electronic ledger 200 may be anchored in response to one or more selected triggers. For instance, anchoring may be triggered when a number of pieces of content that have been recorded since the electronic ledger 200 is last anchored reaches a selected threshold.

A state of the electronic ledger 200 may be represented in any suitable manner. For instance, a state of the electronic ledger 200 may include a cryptographic proof generated based on one or more cryptographic proofs recorded on the electronic ledger 200, such as a root hash of a hash tree with the one or more recorded cryptographic proofs at respective leaf nodes.

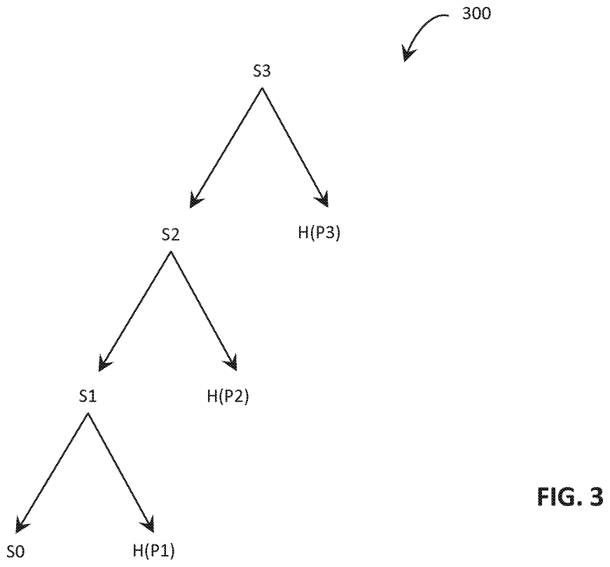

FIG. 3 shows an illustrative tree 300, in accordance with some embodiments. In this example, the tree 300 has four leaf nodes: S0, H(P1), H(P2), and H(P3). The leaf node S0 may represent a state of the illustrative ledger 200 in the example of FIG. 2 before the image P1 is recorded. The leaf nodes H(P1), H(P2), and H(P3) may be cryptographic proofs recorded on the electronic ledger 200 for images P1, P2, and P3, respectively.

In some embodiments, each internal node of the tree 300 may be obtained based on one or more child nodes. For instance, the internal node S1 may represent a state of the electronic ledger 200 after the image P1 is recorded, but before the image P2 is recorded. Accordingly, S1 may include a cryptographic proof generated based on S0 and H(P1), for example, by applying a cryptographic hash function to a result of combining (e.g., concatenating) S0 and H(P1) to obtain a hash H(S0, H(P1)).

Additionally, or alternatively, the internal node S2 may represent a state of the electronic ledger 200 after the image P2 is recorded, but before the image P3 is recorded. Accordingly, S2 may include a cryptographic proof generated based on S1 and H(P2), for example, by applying a cryptographic hash function to a result of combining (e.g., concatenating) S1 and H(P2) to obtain a hash H(S1, H(P2)).

Additionally, or alternatively, the internal node S3 may represent a state of the electronic ledger 200 after the image P3 is recorded. Accordingly, S3 may include a cryptographic proof generated based on S2 and H(P3), for example, by applying a cryptographic hash function to a result of combining (e.g., concatenating) S2 and H(P3) to obtain a hash H(S2, H(P3)).

Referring again to the example of FIG. 2, the electronic ledger 200 may be anchored by recording the states S1 and S3 on the distributed ledger 205. While the state S2 may not be recorded, it may be challenging to find an image P2′ such that S3=H(S2′, H(P3)), where S2′=H(S1, H(P2′)). Thus, the states S1 and S3, which are recorded on the distributed ledger 205, may provide immutability for the image P2.

The inventors have recognized and appreciated that, by anchoring the electronic ledger 200 to the distributed ledger 205, the content provider 105 may be able to prove possession of a selected piece of content within a certain time window by revealing cryptographic proof(s) of one or more other pieces of content recorded during the same time window. This may establish a position of the selected piece of content within a sequence of pieces of content recorded during that time window, without revealing the other piece(s) of content.

For instance, to prove possession of the image P3 before the recordation of S3 on the distributed ledger 205, the content provider 105 may reveal the cryptographic proof H(P2), without revealing the image P2 itself. A verifier may obtain S1 and S3 from the distributed ledger 205, and may compute S2=H(S1, H(P2)). The cryptographic proof H(P3) may also be revealed by the content provider 105, or may be computed by the verifier using the image in question, P3.

The verifier may then verify whether H(S2, H(P3)) matches S3. If so, the verifier may determine that the content provider 105 indeed had possession of the image P3 before the recordation of S3 on the distributed ledger 205.

It should be appreciated that aspects of the present disclosure are not limited to representing a state of the electronic ledger 200 in any particular manner. In some embodiments, a state of the electronic ledger 200 may include an ordered sequence cryptographic proofs recorded on the electronic ledger 200 (e.g., H(P1), H(P2), H(P3), . . . ).

Additionally, or alternatively, different cryptographic hash functions H1, H2, and H3 may be used to obtain cryptographic proofs H1(P1), H2(P2), and H3(P3). Similarly, different cryptographic hash functions H4, H5, and H6 may be used to obtain cryptographic proofs S1″=H4(S0, H1(P1)), S2″=H5(S1″, H2(P2)), and S3″=H6(S2″, H3(P3)).

It should also be appreciated that aspects of the present disclosure are not limited to obtaining a cryptographic proof in any particular manner. In some embodiments, a cryptographic proof may be obtained using a zero-knowledge protocol, so that the content provider 105 may be able to prove knowledge of a piece of content without revealing the content or any other information. The zero-knowledge protocol may be interactive or non-interactive.

For instance, a zero-knowledge proof may be provided that proves the content provider 105 is in possession of a piece of content P such that H(P)=h, where H is a given hash function, and h is a given hash value.

As discussed above, while a piece of content may be stored in a file with metadata that purports to establish authorship of the content, such metadata may be easily scrubbed and/or forged. Accordingly, in some embodiments, techniques are provided for associating metadata with a piece of content in a more secure manner. For instance, metadata may be embedded into a piece of content using a watermarking or steganography technique.

In some embodiments, an embedding technique may be selected that is robust against one or more manipulations. As an example, an embedding technique for images may be selected that is robust against cropping, resizing, rotating, flipping, color correction, compression followed by decompression or vice versa, etc. This may allow a creator of a piece of content to establish authorship, and thereby retain rights to, and receive recognition for, the content, even if the content has been manipulated by a digital pirate or an entity claiming a fair use exception.

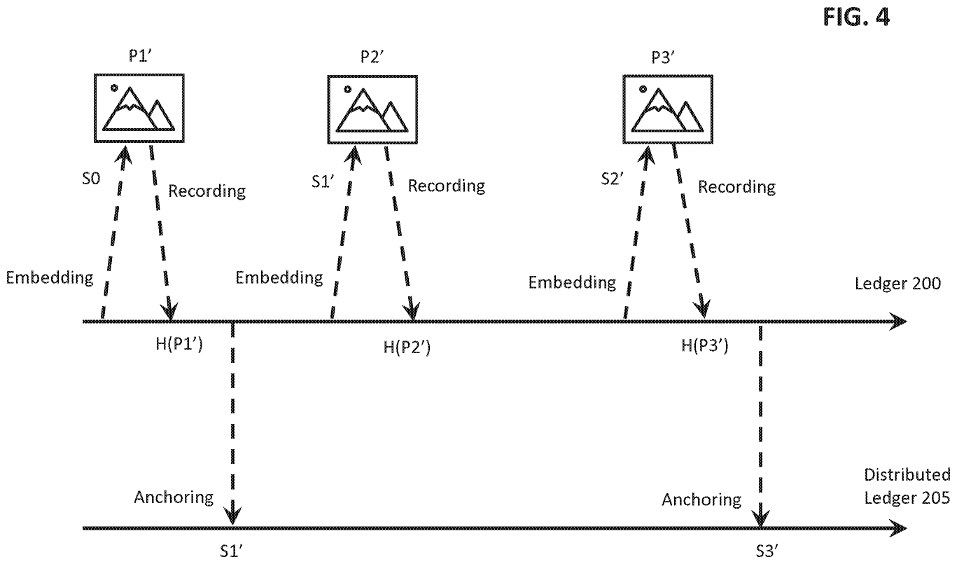

FIG. 4 shows the illustrative ledger 200 in the example of FIG. 2, in accordance with some embodiments. In this example, when a piece of content is created by the content provider 105, a suitable embedding technique (e.g., a watermarking or steganography technique) is used to embed a current state of the electronic ledger 200 into the newly created piece of content.

For instance, the state S0 may be embedded into the image P1 using a covert watermarking or steganography technique, thereby obtaining an image P1′ that may be visually indistinguishable from the image P1. A cryptographic proof of the image P1′ (e.g., H(P1′)) may be recorded on the electronic ledger 200, and a state S1′ of the electronic ledger 200 (e.g., H(S0, H(P1′))) may be recorded on the distributed ledger 205.

Additionally, or alternatively, the state S1′ may be embedded into the image P2 using a covert watermarking or steganography technique, thereby obtaining an image P2′ that may be visually indistinguishable from the image P2. A cryptographic proof of the image P2′ (e.g., H(P2′)) may be recorded on the electronic ledger 200.

Additionally, or alternatively, a state S2′ of the electronic ledger 200 (e.g., H(S1′, H(P2′))) may be embedded into the image P3 using a covert watermarking or steganography technique, thereby obtaining an image P3′ that may be visually indistinguishable from the image P3. A cryptographic proof of the image P3′ (e.g., H(P3′)) may be recorded on the electronic ledger 200, and a state S3′ of the electronic ledger 200 (e.g., H(S2′, H(P3′))) may be recorded on the distributed ledger 205.

In some embodiments, the content provider 105 may share the image P2′ with one or more recipients, instead of the image P2. In case of an authorship dispute, the content provider 105 may prove authorship of the image P2′ by providing a retrieval function corresponding to the embedding function used to embed S1′ into the image P2. A verifier may obtain S1′ from the distributed ledger 205, and may apply the retrieval function to the image P2′ to obtain a result. If the result matches S1′, the verifier may determine that the content provider 105 is indeed the author of the image P2′.

Additionally, or alternatively, the content provider 105 may share the image P3′ with a recipient, instead of the image P3. In case of an authorship dispute, the content provider 105 may prove authorship of the image P3′ by providing: (i) the cryptographic proof H(P2′) and (ii) a retrieval function corresponding to the embedding function used to embed S2′ into the image P3. A verifier may obtain S1′ from the distributed ledger 205, and may compute S2′=H(S1′, H(P2′)). The verifier may then apply the retrieval function to the image P3′ to obtain a result. If the result matches S2′, the verifier may determine that the content provider 105 is indeed the author of the image P3′.

While certain details of implementation are described in connection with the examples of FIGS. 2-4, it should be appreciated that such details are provided solely for purposes of illustration. For instance, as discussed in connection with the example of FIG. 2, cryptographic proofs may be obtained using different cryptographic techniques, such as cryptographic hash functions, zero-knowledge proof protocols, etc.

Moreover, aspects of the present disclosure are not limited to anchoring the electronic ledger 200 to the distributed ledger 205, or to embedding a current state of the electronic ledger 200 into a piece of content. In some embodiments, only embedding may be performed, without anchoring, or vice versa. In that respect, the inventors have recognized and appreciated that embedding a state of the electronic ledger 200 into a piece of content may serve as a form of anchoring for the electronic ledger 200, in addition to, or instead of, anchoring to the distributed ledger 205.

The inventors have further recognized and appreciated that, while a message embedded into a piece of content using a covert watermarking technique may be visually imperceptible, a digital pirate may be able to detect the presence of the embedded message, and may manipulate the content so as to remove the embedded message, or to render the embedded message unretrievable.

Accordingly, in some embodiments, a steganography technique may be used to embed a message (e.g., a state of the electronic ledger 200) into a piece of content, so that it may be impossible or computationally/economically infeasible for a digital pirate to detect the presence of the embedded message. As a result, the pirate may use the content without attempting to remove or degrade the embedded message.

However, it should be appreciated that aspects of the present disclosure are not limited to embedding any particular information into a piece of content, using any particular embedding technique, or performing any embedding at all. In some embodiments, license information may be embedded into a piece of content, in addition to, or instead of, a state of the electronic ledger 200. Any suitable license information may be embedded, such as creator identity, year(s) of creation, licensee identity, license term, one or more permissions, and/or one or more restrictions.

For instance, different copies of the same piece of content may be generated, respectively, for different licensees. The copies may appear identical when inspected visually, but may have embedded therein license information identifying the respective licensees. If an unauthorized use of the content is found, the license information may be retrieved, which may then be used to trace the unauthorized use to a particular licensee.

As described in connection with the example of FIG. 1, the illustrative content management platform 100 may allow a user (e.g., the content requester 110) to access one or more pieces of content. Such a platform is sometimes referred to herein as a hosting platform. For instance, a hosting platform may provide an interface (e.g., a web interface or a remote API) via which the user may search for desired content, and/or request a particular piece of content by providing a CID.

The inventors have recognized and appreciated that a user may wish to ascertain that a piece of content is trusted before requesting the content. For instance, the user may wish to verify an identity of an entity that is making the content available (e.g., a creator or an authorized provider of the content). Additionally, or alternatively, the user may wish to confirm integrity and/or authenticity the content.

In some implementations, trust may be established via a hosting platform. For instance, a user device may establish a secure connection with the hosting platform by verifying a certificate issued by a certificate authority (CA) to the hosting platform. As an example, the hosting platform may have a cryptographic key pair, and the certificate may bind a public key of the cryptographic key pair to an identity of the hosting platform. The CA may also have a cryptographic key pair (different from that of the hosting platform), and may sign the hosting platform's certificate using the CA's private key. The user device may look up the CA's public key from a list of trusted CAs and corresponding public keys, and may use the CA's public key to verify the certificate. Upon successful verification of the certificate, the user device may use the public key bound to the hosting platform to verify signatures on messages received from the hosting platform. Once the hosting platform is thus authenticated, the user device may trust content received from the hosting platform and/or information provided by the hosting platform about the content.

However, the inventors have recognized and appreciated that the centralized approach described above may not always be reliable. For instance, if the CA is compromised, an attacker may use the CA's private key to forge certificates. Furthermore, if the hosting platform is compromised, an attacker may use the hosting platform's private key to distribute malicious or otherwise unreliable content. Further still, the hosting platform may distribute content from third party creators without sufficient vetting of the creators' identities or the content.

Accordingly, in some embodiments, a decentralized approach may be used instead of, or in addition to, a centralized approach for establishing trust. For instance, a piece of content may be associated with a decentralized identifier (DID) of an entity that is making the content available. Such a content provider may be an individual or an organization which has: (i) created the content, (ii) purchased or licensed the content from an owner of the content, or (iii) been authorized by the owner to sell or license the content on behalf of the owner.

The DID may be generated in any suitable manner, for example, by a self-sovereign identity (SSI) system implementing one or more specifications provided by the Decentralized Identity Foundation (DIF) for issuing DIDs, verifiable credentials (VCs), verifiable presentations (VPs), etc.

In some embodiments, a content provider's DID may be recorded in an identity registry, along with information that may be used to obtain an associated DID document (e.g., the DID document itself, and/or information that may be used to resolve the DID into the DID document). The identity registry may be public, so that attempts to forge DID documents may be readily detectable.

The identity registry may be implemented using a distributed ledger or a data store of some other type. Additionally, or alternatively, the identity registry may be maintained independently from a hosting platform. However, it should be appreciated that aspects of the present disclosure are not limited to implementing the identity register in any particular manner, or at all. In some embodiments, the identity registry may be maintained by a hosting platform, and may be public or permissioned (e.g., accessible to all or a selected set of users of the hosting platform).

A DID document associated with a DID may include any suitable information about an entity identified by the DID (also referred to as a subject of the DID). Examples of such information include, but are not limited to, a description of the subject, one or more methods for verifying that an entity that purports to control the DID indeed has such control, one or more methods for interacting with the subject of the DID, etc.

Thus, in some embodiments, a user may use a content provider's DID to look up an identity registry, and thereby obtain an associated DID document. The user may then use information from the DID document to confirm integrity and/or authenticity of a piece of content. For instance, the content may be provided to the user along with a signature purportedly generated over the content using a private key controlled by the content provider (i.e., the subject of the DID). The user may use a public key obtained based on the DID document to verify the signature. In this manner, the user may be able to ascertain that the content is trusted (provided the user trusts the content provider), even if a hosting platform via which the content is obtained is untrusted.

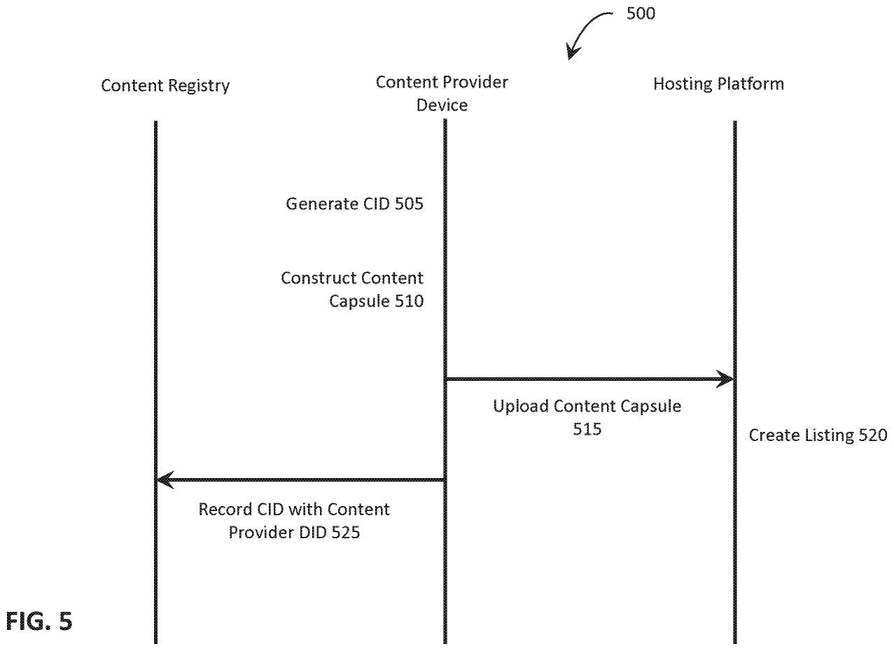

FIG. 5 shows an illustrative process 500 for making a piece of content available, in accordance with some embodiments. For instance, the process 500 may be performed by a device of a content provider, a hosting platform, and/or a content registry. The content provider may be an individual such as the content provider 105 in the example of FIG. 1, or an organization such as a studio, a gallery, a museum, a retailer, etc. The hosting platform may be the illustrative content management platform 100 in the example of FIG. 1. The content registry may be implemented using the illustrative distributed ledger 205 in the example of FIG. 2.

However, it should be appreciated that aspects of the present disclosure are not so limited. In some embodiments, the content registry may be implemented using a different distributed ledger, or a data store of some other type.

In some embodiments, the content provider device may generate a piece of content (e.g., image, video, audio, text, etc.). The content may be stored, in encrypted or unencrypted form, in a local storage (e.g., hard disk, flash memory, network-attached storage, etc.) and/or a remote storage (e.g., cloud storage).

Additionally, or alternatively, the content provider device may store a record for the content on an electronic ledger. For instance, as described in connection with the example of FIG. 2, the content may be recorded on the illustrative ledger 200, which may be anchored to the illustrative distributed ledger 205.

Additionally, or alternatively, the content provider may embed selected information into the content. For instance, as described in connection with the example of FIG. 4, information evidencing authorship, license information, and/or other information, may be embedded into the content (e.g., using a watermarking or steganography technique). The resulting content, with the embedded information, is sometimes referred to herein as marked content. The original content, without the embedded information, is sometimes referred to herein as unmarked content.

Referring again to the example of FIG. 5, the content provider device may, at act 505, generate a CID for the content. For instance, the content provider device may apply a suitable hash function to the unmarked content to obtain a hash, and may generate a CID based on the hash. In this manner, it may be highly unlikely that the same CID is generated for two different pieces of content.

However, it should be appreciated that aspects of the present disclosure are not limited to generating a CID in any particular manner, or at all. In some embodiments, the hash may be obtained by applying the hash function to the marked content, as opposed to the unmarked content.

At act 510, the content provider device may construct a content capsule for the content. The content capsule may be any suitable data structure associated the content. For instance, the content capsule may include the CID generated at act 505, the content itself (which may be marked or unmarked), and/or any suitable metadata associated with the content (e.g., as described in connection with the example of FIG. 1).

However, it should be appreciated that aspects of the present disclosure are not limited to generating a content capsule in any particular manner, or at all. In some embodiments, the content capsule may not include the content itself. Additionally, or alternatively, the metadata in the content capsule may include descriptive information for the content, such as title, topic, summary, thumbnail image, text excerpt, audio snippet, video snippet, etc.

At act 515, the content provider device may upload the content capsule generated at act 510 to the hosting platform. As described in connection with the example of FIG. 1, the hosting platform may provide a content marketplace through which users may list, search for, view, purchase, sell, and/or license content. At act 520, the hosting platform may create a listing for the content based on the content capsule uploaded at act 515, and may make the listing available for searching, viewing, downloading, etc.

In some embodiments, the hosting platform may create a container in a content storage, and may associate the listing with the container. Some or all data from the content capsule uploaded at act 515 may be stored in the container, such as the CID of the content, the content itself (which may be marked or unmarked), and/or the associated metadata.

However, it should be appreciated that aspects of the present disclosure are not limited to having a container that is created by the hosting platform, or any container at all. In some embodiments, the content provider may create the container in the content storage, and may provide, to the hosting platform, a pointer (e.g., a URL) to the container. For instance, the pointer may be included in the content capsule uploaded to the hosting platform.

In some embodiments, the container in the content storage may have an identifier assigned by the content provider. Any suitable identifier may be used. As an example, the content provider may generate a cryptographic key pair, and may use a public key of the key pair to obtain an identifier for the container (e.g., by applying a hash function to the public key). As another example, an identifier may be obtained based on the content stored in the container (e.g., by applying a hash function to a portion of the content).

It should be appreciated that aspects of the present disclosure are not limited to creating a new container for each content capsule. In some embodiments, a content capsule may include an updated version of content of another content capsule. Accordingly, the subsequent content capsule may indicate a CID of the prior content capsule, and the hosting platform may use that CID to identify a corresponding container, and may store the updated content in the container.

The updated content may or may not replace the prior content in the container. In the latter case, the different versions in the container may be differentiated in any suitable manner, for example, using timestamps, version numbers, etc.

As discussed above, enhanced trust may be provided by associating, in a verifiable manner, a piece of content with an identity of a provider of the content. Accordingly, at act 525 in the example of FIG. 5, the content provider device may record, in the content registry, the CID generated at act 505 along with a DID of the content provider.

In some embodiments, the DID of the content provider may be issued by the content provider itself. For instance, the content provider device may generate the DID and/or an associated DID document according to an SSI specification. Additionally, or alternatively, the content provider device may generate a cryptographic key pair, and a public key of the key pair may be included in the DID document.

In some embodiments, the content provider may bind the key pair to the DID by recording the DID in an identity registry (not shown in FIG. 5) along with information that may be used to obtain the DID document (e.g., the DID document itself, and/or information that may be used to resolve the DID into the DID document). The content provider may effectuate such binding when the DID is generated, or at a later time (e.g., when a higher level of trust is desired).

It should be appreciated that aspects of the present disclosure are not limited to recording any particular information in the content registry, or at all. In some embodiments, security information, such as a cryptographic hash of the content (which may be marked or unmarked), may be recorded in addition to, or instead of, the DID of the content provider. The cryptographic hash may be signed by the content provider using the private key corresponding to the public key included in the DID document associated with the DID of the content provider.

In this manner, a user (e.g., the content requester 110 in the example of FIG. 1) may use the DID of the content provider to look up the identity registry, and thereby obtain the associated DID document. The user may then use information from the DID document to confirm integrity and/or authenticity of content received from the hosting platform.

For instance, the user may use the public key in the DID document to verify the content provider's signature on the cryptographic hash recorded in the content registry. Additionally, or alternatively, the user may generate a cryptographic hash based on the content received from the hosting platform, and may compare this newly generated cryptographic hash against the cryptographic hash recorded in the content registry.

If the content provider's signature is successfully verified, and the newly generated cryptographic hash matches the cryptographic hash recorded in the content registry, the user may determine that the content is trusted (provided the user trusts the content provider), even if the hosting platform is untrusted.

It should be appreciated that aspects of the present disclosure are not limited to recording any particular security information in the content registry, or at all. In some embodiments, security information recorded in the content registry may include a DID of the hosting platform, which may be signed by the content provider using the private key corresponding to the public key included in the DID document associated with the DID of the content provider. In this manner, the user may verify that the hosting platform has indeed been authorized by the content provider to list the content.

Additionally, or alternatively, the security information recorded in the content registry may include a DID of the content storage, which may be signed by the content provider using the private key corresponding to the public key included in the DID document associated with the DID of the content provider. In this manner, the user may verify that the content storage has indeed been authorized by the content provider to store the content.

In some embodiments, any of the security information described above may be included (e.g., as metadata) in the content capsule and/or the container in the content storage. This may be done in addition to, or instead of, recording the security information in the content registry.

Although techniques are described herein for using a content registry (e.g., the illustrative content registry in the example of FIG. 5) to enhance trust, it should be appreciated that aspects of the present disclosure are not limited to using a content registry in any particular manner, or at all. In some embodiments, a content registry may, additionally or alternatively, be used to promote access. For instance, a content registry may, upon receiving a query identifying a content provider, determine the content provider's DID, and return all CIDs associated with that DID. As such, the content registry may provide a unified mechanism for a user to discover content from a selected content provider, even if the content provider has made different pieces of content available, respectively, through different hosting platforms.

Additionally, or alternatively, a content registry may allow a user to discover related content. For instance, as described in connection with the example of FIG. 1, a piece of content may be derived from, include, or otherwise be related to one or more portions of another piece of content. Accordingly, in some embodiments, a CID of a piece of content may be recorded in a content registry along with a CID of a piece of related content.

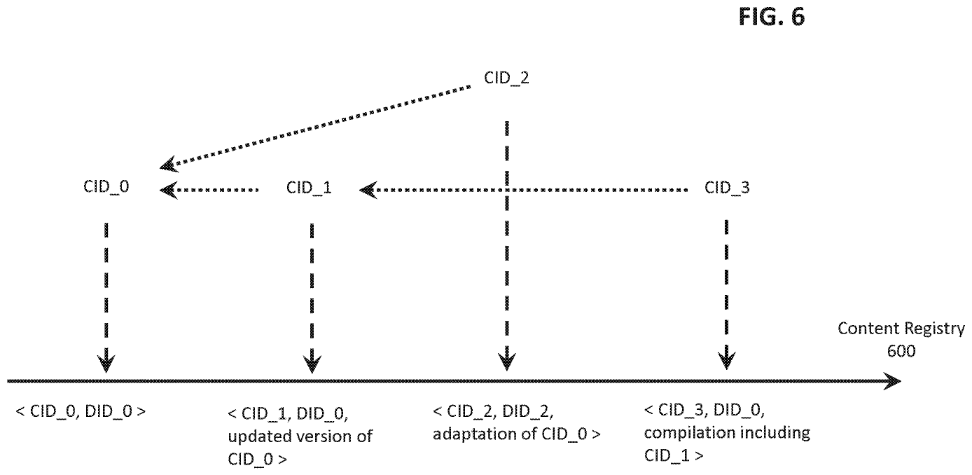

FIG. 6 shows an illustrative content registry 600, in accordance with some embodiments. For instance, the content registry 600 may be the illustrative content registry in the example of FIG. 5, and may be implemented in any suitable manner (e.g., using the illustrative distributed ledger 205 in the example of FIG. 2, a different distributed ledger, or a data store of some other type).

In this example, CID_0, . . . , CID_3 may be recorded in the content registry 600, corresponding, respectively, to four pieces of content. The content identified by CID_0, CID_1, and CID_3 may be associated with the same content provider (identified by DID_0), whereas the content identified by CID_2 may be associated with a different content provider (identified by DID_2).

In some embodiments, a piece of content may be recorded in the content registry 600 with an indication of a relationship between that piece of content and another piece of content. As an example, the content identified by CID_1 may be an updated version of the content identified by CID_0, while the content identified by CID_3 may be a compilation that includes the content identified by CID_1. As another example, the content identified by CID_2 may be an adaptation of the content identified by CID_0.

In this manner, a user may use the content registry 600 to discover version history of a piece of content. For instance, a user may submit a query with CID_0, and may discover that a subsequent version exists (e.g., the content identified by CID_1). This may be particularly useful if the different versions are made available, respectively, via different hosting platforms.

Additionally, or alternatively, a user may submit a query with CID_1, and may discover that a previous version exists (e.g., the content identified by CID_0), even if the previous version is no longer available via any hosting platform.

Additionally, or alternatively, a user may use the content registry 600 to gain access to a piece of content. For instance, the user may have obtained a license from the content provider DID_0 for the content identified by CID_0. The license may include permission to access all subsequent versions of the content identified by CID_0. Accordingly, the user may request access to the content identified by CID_1 by referencing the previously obtained license and the record in the content registry 600 indicating that the content identified by CID_1 is an updated version of the content identified by CID_0.

It should be appreciated that aspects of the present disclosure are not limited to having pieces of content that are related in any particular manner, or at all. In some embodiments, a piece of content may be a translation, an excerpt, a summary, or some other derivative of another piece of content.

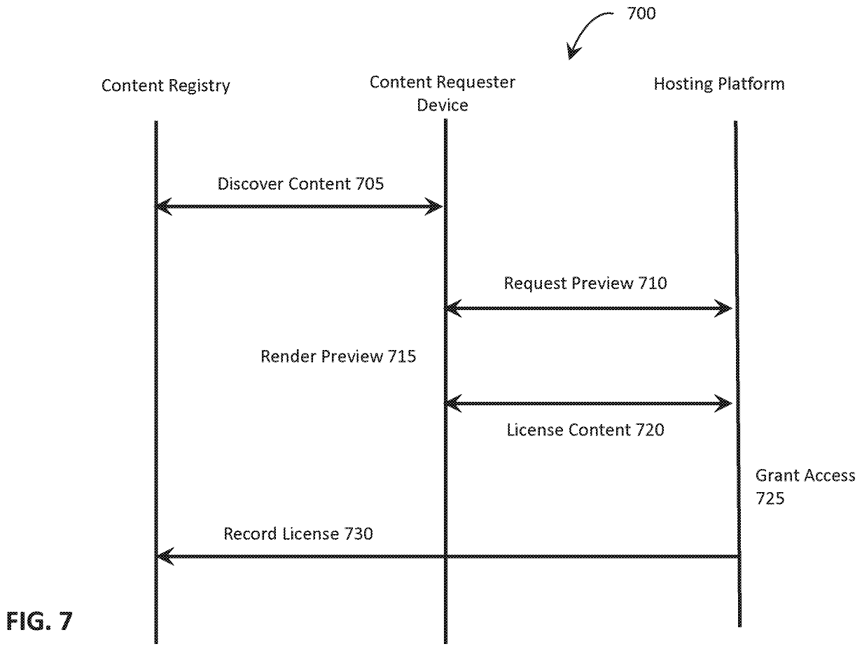

FIG. 7 shows an illustrative process 700 for discovering and/or licensing content, in accordance with some embodiments. For instance, the process 700 may be performed by a device of a user (e.g., the content requester 110 in the example of FIG. 1), a hosting platform (e.g., the illustrative content management platform 100 in the example of FIG. 1), and/or a content registry (e.g., the illustrative content registry in the example of FIG. 5).

In some embodiments, the user may wish to discover content made available by a selected content provider. The content provider may be an individual such as the content provider 105 in the example of FIG. 1, or an organization such as a studio, a gallery, a museum, a retailer, etc.

In some embodiments, the content provider may have an associated DID (e.g., as described in connection with the example of FIG. 5). The user may obtain the content provider's DID in any suitable manner. As an example, the user may obtain the DID at a physical establishment of the content provider (e.g., by scanning a QR code from a physical display). As another example, the user may obtain the DID from a web site of the content provider. As yet another example, the user may use another identifier of the content provider (e.g., a name, a phone number, a physical address, an email address, a social media handle, a domain name, etc.) to look up the DID from a trusted service.

Referring to the example of FIG. 7, the content requester device may, at act 705, send a request to the content registry. In some embodiments, the request may indicate the content provider's DID. Additionally, or alternatively, the request may identify the content provider in another way (e.g., by providing a name, a phone number, a physical address, an email address, a social media handle, a domain name, etc.), and the content registry may be configured to match the request to the DID of the content provider. Additionally, or alternatively, the request may indicate a CID of a piece of content provided by the content provider, and the content registry may be configured to look up a record associated with the CID, and obtain the DID of the content provider based on the record.

In some embodiments, the content registry may look up and return to the content requester device one or more records associated with the DID of the content provider. For instance, in response to a request indicating DID_0 in the example of FIG. 6, the content register may return records for CID_0, CID_1, and CID_3.

It should be appreciated that aspects of the present disclosure are not limited to searching the content registry based on a content provider's DID. In some embodiments, the content requester device may submit a CID, or select a CID from a plurality of CIDs returned by the content registry at act 705. In response, the content registry may use the CID to look up related content. For instance, in response to the content requester device selecting CID_0 in the example of FIG. 6, the content register may return records for CID_1, CID_2, and CID_3.

Any suitable technique or combination of techniques may be used to look up related content in the content registry. For instance, a first record may be considered to be connected to a second record if: either the first record references the second record, or vice versa. A suitable graph traversal technique (e.g., depth first search, breadth first search, etc.) may be used to identify one or more records that are connected to the record for CID_0, directly or indirectly via one or more other records.

Additionally, or alternatively, a directional search may be carried out. As an example, a first record may be considered to be connected to a second record if the first record references the second record. As another example, a first record may be considered to be connected to a second record if the first record is referenced by the second record. In either example, a suitable graph traversal technique (e.g., depth first search, breadth first search, etc.) may be used to identify one or more records that are connected to the record for CID_0, directly or indirectly via one or more other records.

In some embodiments, the content requester device may indicate one or more criteria for narrowing a search. For instance, the content requester device may request records that are at most N hops away from the record for CID_0 for some suitable N>=1.

Additionally, or alternatively, a suitable taxonomy may be used to label some or all content recorded in the content registry. For instance, a record in the content registry may include one or more classification labels. Such a label may be assigned by a content provider creating the record, or by the content registry (e.g., based on content and/or metadata contained in the record). Accordingly, the content requester device may search the content registry based on one or more classification labels.

Additionally, or alternatively, the content requester device may search the content registry using a natural language query. For instance, records stored in the content registry may include pieces of content and/or any suitable metadata associated therewith. The content registry may be configured to match the natural language query to one or more records based on the content and/or the metadata.

Returning to the example of FIG. 7, the content requester device may, at act 710, request to preview one or more pieces of content. For instance, the user may select a CID from a plurality of CIDs returned by the content registry at act 705, and the content requester device may submit the CID to the hosting platform to request a preview.

In response, the hosting platform may use the CID to access a content storage, and may return suitable material for preview (e.g., thumbnail image, text excerpt, audio snippet, video snippet, etc.). For instance, the hosting platform may use the CID look up a container from the content storage, and may retrieve the preview material from the container.

Additionally, or alternatively, the hosting platform may return license information associated with the CID. For instance, the content provider may, when generating a content capsule for the CID (e.g., as described in connection with the example of FIG. 5), include license information such as license term (e.g., definite duration or perpetual), license fee, terms of use, etc. When the content capsule is uploaded to the hosting platform, the license information may be propagated to the corresponding container. Accordingly, the hosting platform may retrieve the license information from the container, and return the license information to the content requester device at act 710 in the example of FIG. 7.

At act 715, the content requester device may render the preview material received at act 710 to the user. Additionally, or alternatively, the content requester device may render the license information to the user. If the user accepts the license offer, the content requester device may, at act 720, initiate a request to license the content. In some embodiments, the request may include identifying information for the user, for example, a DID of the user.

The hosting platform may respond to the request to license the content in any suitable manner. For instance, the hosting platform may instruct the user to submit a payment (e.g., to the content provider directly, or to the hosting platform or another entity authorized by the content provider to accept payment). Additionally, or alternatively, the hosting platform may instruct the user to provide one or more attestations (e.g., age, residency, etc.). Additionally, or alternatively, the hosting platform may forward relevant information submitted by the user (e.g., the user's DID or other identifying information, age, residency, etc.) to the content provider for approval.

If the hosting platform determines that a license may be granted to the user, the hosting platform may, at act 725, grant the user access the content. As an example, the hosting platform may configure the corresponding container in the content storage to indicate that a license has been granted to the user. For instance, the user's DID or other identifying information may be added to a list of current licensees. Additionally, or alternatively, one or more permissions and/or restrictions may be associated with the user, such as type of access (e.g., view only or downloadable), maximum number of access(es), maximum number of device(s), time of access (e.g., during or outside one or more windows), etc.

In some embodiments, the hosting platform may return, to the content requester device, information that may be used to access the licensed content. For instance, the hosting platform may return a pointer (e.g., URL) to the container in the content storage. Additionally, or alternatively, the hosting platform may return a verifiable credential indicating that a license has been granted to the user. The verifiable credential may include the CID and/or a cryptographic hash of the content, the user's DID or other identifying information, license term, etc.

In some embodiments, the verifiable credential may be prepared according to a Verifiable Credential specification provided by DIF, and may be signed using a private key associated with a DID of the hosting platform. Accordingly, the user may present the verifiable credential to the content storage to request access to the content, and the content storage may verify the verifiable credential using a public key associated with the DID of the hosting platform. The public key may be obtained in any suitable manner, for example, by using the DID of the hosting platform to look up a DID document from an identity registry (not shown in FIG. 7). Additionally, or alternatively, the content storage may check the identity registry to confirm there is no revocation notice associated with an identifier of the verifiable credential.

The inventors have recognized and appreciated that a decentralized approach for access control may be desirable in some instances. For example, the content storage may be controlled by an entity other than the hosting platform, such as the content provider itself, or a storage service authorized by the content provider. The illustrative credential-based approach described above may allow the user to request content directly from the content storage, without involvement of the hosting platform.

However, it should be appreciated that aspects of the present disclosure are not limited to performing access control in any particular manner, or at all. In some embodiments, the hosting platform may retrieve the content from the content storage, and may serve the content to the content requester device.

Referring again to the example of FIG. 7, the hosting platform may, at act 730, record the license granted to the user in the content registry. Any suitable information may be recorded, such as a suitable identifier of the license, the CID and/or a cryptographic hash of the licensed content, the user's DID or other identifying information, the content provider's DID or other identifying information, license information, hosting information (e.g., the DID of the hosting platform), etc. Some or all of the recorded information may be encrypted, hashed, or otherwise secured (e.g., to protect privacy of the user and/or the content provider).

In some embodiments, the recorded information may be signed by the hosting platform, for example, using a private key associated with the DID of the hosting platform. Accordingly, any entity may be able to verify authenticity of the recorded information by using the DID of the hosting platform to look up a DID document from an identity registry (not shown in FIG. 7), obtaining a public key based on the DID document, and using the public key to verify the signature.

While certain implementation details are described above in connection with the examples of FIGS. 5-7, it should be appreciated that such details are provided solely for purposes of illustration. For instance, aspects of the present disclosure are not limited to having a content registry with search capabilities. In some embodiments, the hosting platform may allow one or more search engines to crawl and index listings of content (e.g., based on metadata contained in the listings, but not the content itself).

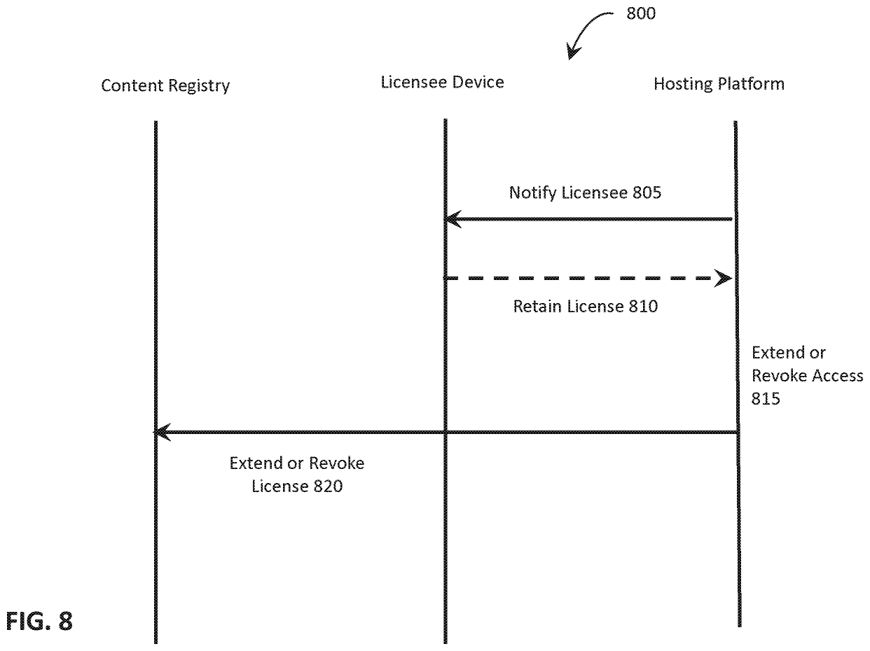

FIG. 8 shows an illustrative process 800 for managing a license, in accordance with some embodiments. For instance, the process 800 may be performed a device of a user (e.g., the content requester 110 in the example of FIG. 1), the illustrative hosting platform in the example of FIG. 7, and/or the illustrative content registry in the example of FIG. 7.

In some instances, a license granted to the user may expire after a period of time indicated in the license. In other instances, a content provider (e.g., the content provider 105) may wish to revoke a license. For example, the content provider may detect a user's violation of one or more restrictions imposed in a license.

Accordingly, the content provider may send a request (not shown in FIG. 8) to the hosting platform to revoke the license. The request may include any suitable information, such as an identifier of the license, a CID and/or a cryptographic hash of licensed content, the user's DID or other identifying information, license information, one or more reasons for revocation, etc. The hosting platform may initiate the process 800 in response to such a request.

Referring to the example of FIG. 8, the hosting platform may, at act 805, send a notification to the licensee device regarding a license previously granted to the user. The notification may indicate the license is about to expire or is being revoked, one or more reasons for revocation, and/or one or more actions that the user may take to retain the license (e.g., submit payment to renew the license, cease one or more activities that are in violation of the license, etc.).

If the user elects to retain the license, the licensee device may, at act 810, send a response to the hosting platform. In some embodiments, the user may follow one or more instructions provided by the hosting platform at act 805. The response sent to the hosting platform at act 810 may include suitable evidence that the user has followed the one or more instructions. The hosting platform may forward such evidence to the content provider for approval.

Upon receiving a response from the licensee device, the hosting platform may determine whether the license may be retained. The hosting platform may make this determination independently, or based on input from the content provider. In case of a proposed revocation based on license violation, if the hosting platform determines the license may be retained, the hosting platform may take no action, thereby allowing the license to continue. In case of an upcoming license expiration, if the hosting platform determines the license may be retained, the hosting platform may, at act 815, extend access previously granted to the user.

For instance, the hosting platform may configure a corresponding container in a content storage to indicate that the license has been extended. Additionally, or alternatively, the hosting platform may issue a new verifiable credential (e.g., with an updated license term).

If no response is received from the licensee device after a selected amount of time has elapsed after the notification of act 805, the hosting platform may, at act 815, revoke the access previously granted to the user. For instance, the hosting platform may configure the corresponding container in the content storage to indicate that the license has been revoked (e.g., by removing the user's DID or other identifying information from a list of current licensees).

Additionally, or alternatively, the hosting platform may revoke a verifiable credential previously issued to the user as evidence of the license. For example, the hosting platform may record, in an identity registry (not shown in FIG. 8), a revocation notice comprising an identifier of the verifiable credential.

Referring again to the example of FIG. 8, the hosting platform may, at act 820, record the extension or revocation of the license in the content registry. Any suitable information may be recorded, such as the identifier of the license, the CID and/or the cryptographic hash of the licensed content, the user's DID or other identifying information, the content provider's DID or other identifying information, license information (e.g., the updated license term, in case of license extension), one or more reasons for revocation (in case of license violation), hosting information (e.g., a DID of the hosting platform), etc. Some or all of the recorded information may be encrypted, hashed, or otherwise secured (e.g., to protect privacy of the user and/or the content provider).

In some embodiments, the recorded information may be signed by the hosting platform, for example, using a private key associated with the DID of the hosting platform. Accordingly, any entity may be able to verify authenticity of the recorded information by using the DID of the hosting platform to look up a DID document from an identity registry (not shown in FIG. 8), obtaining a public key based on the DID document, and using the public key to verify the signature.

The inventors have recognized and appreciated that, sometimes, a user may wish to transfer a license to another entity. While a license may include a provision prohibiting transfers without a licensor's consent, it may be challenging to enforce such a provision in practice.

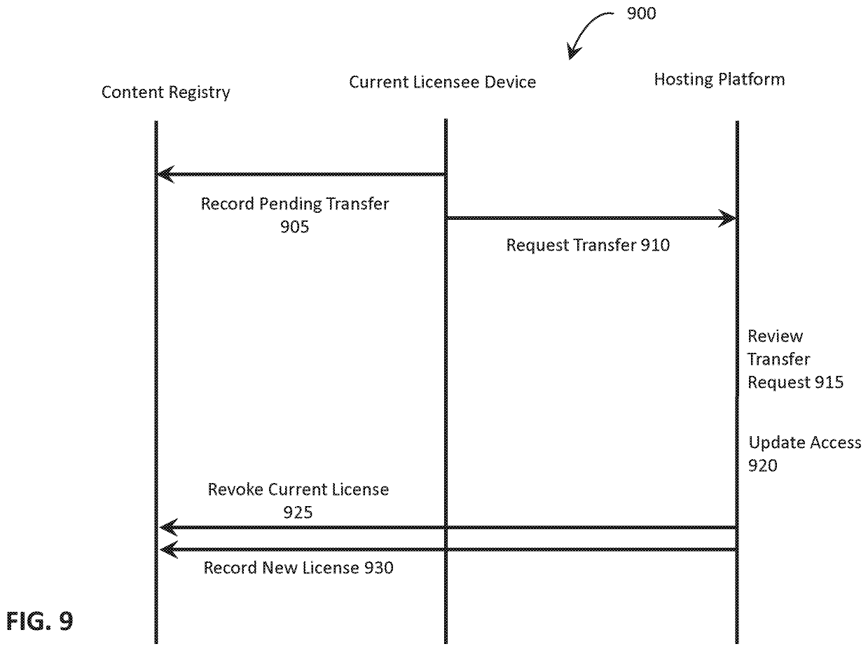

FIG. 9 shows an illustrative process 900 for transferring a license, in accordance with some embodiments. For instance, the process 900 may be performed by a device of a user, the illustrative hosting platform in the example of FIG. 7, and/or the illustrative content registry in the example of FIG. 7.

In this example, the user previously obtained a license for a piece of content (e.g., as described in connection with the example of FIG. 7), but now wishes to transfer the license to another entity. For clarity, the user and the other entity are hereafter referred to as the current licensee and the new licensee, respectively.

In some embodiments, the current licensee and the new licensee may interact and agree to a transfer. For instance, the current licensee may share relevant information with the new licensee, such as an identifier of the license, a CID and/or a cryptographic hash of the licensed content, the current licensee's DID or other identifying information, the content provider's DID or other identifying information, license information, hosting information (e.g., a DID of the hosting platform), etc.

Likewise, the new licensee may share relevant information with the current licensee, such as the new licensee's DID or other identifying information, payment information, etc. Additionally, or alternatively, the new licensee may look up a record of the license in the content registry (e.g., using the identifier of the license and/or the CID of the licensed content), and may use the DID of the hosting platform to verify authenticity of the recorded information (e.g., as described in connection with act 730 in the example of FIG. 7). Additionally, or alternatively, the new licensee may check the content registry to confirm there is no notice of pending transfer against the license.

Referring to the example of FIG. 9, the current licensee device may, at act 905, record a notice in the content registry to indicate that a transfer is pending. The notice may include any suitable information, such as the identifier of the license, the CID and/or the cryptographic hash of the licensed content, the current licensee's DID or other identifying information, the content provider's DID or other identifying information, the new licensee's DID or other identifying information, license information, hosting information (e.g., the DID of the hosting platform), etc. Some or all of the recorded information may be encrypted, hashed, or otherwise secured (e.g., to protect privacy of the current license, the new licensee, and/or the content provider).

In some embodiments, the recorded information may be signed by the current licensee device, for example, using a private key associated with the DID of the current licensee. Accordingly, any entity may be able to verify authenticity of the recorded information by using the DID of the current licensee to look up a DID document from an identity registry (not shown in FIG. 9), obtaining a public key based on the DID document, and using the public key to verify the signature.

In some embodiments, the new licensee may withhold payment to the current licensee until the notice of pending transfer has been recorded in the content registry. This may prevent the current licensee from collecting payments from multiple entities simultaneously with a promise to transfer the license. For instance, a third entity to which the current licensee promises to transfer the license may see that a transfer is already pending against the license, and may refuse to submit payment unless the current licensee is able to show sufficient evidence that the transfer has been canceled.

Referring again to the example of FIG. 9, the current licensee device may, at act 910, send a request to the hosting platform to request that the license be transferred to the new licensee. The request may include any suitable information, such as the identifier of the license, the CID and/or the cryptographic hash of the licensed content, the current licensee's DID or other identifying information, the content provider's DID or other identifying information, the new licensee's DID or other identifying information, the license information, etc.

Additionally, or alternatively, the request may include evidence that the new licensee has accepted the license. As an example, the new licensee may use a private key associated with the DID of the new licensee to generate a signature over a suitable data structure, such as a data structure comprising the identifier of the license, the license information, the new licensee's age and/or residency, etc. The new licensee may send the data structure and/or the signature to the current licensee, which may in turn forward the data structure and/or the signature to the hosting platform.

At act 915, the hosting platform may review the transfer request received at act 910, and may determine whether to approve the transfer. The hosting platform may make this determination independently, or based on input from the content provider. For instance, the hosting platform may use the DID of the new licensee to look up a DID document from an identity registry (not shown in FIG. 9), obtain a public key based on the DID document, and use the public key to verify the signature evidencing the new licensee's acceptance of the license.

Additionally, or alternatively, the hosting platform may forward relevant information submitted by the current licensee (e.g., the new licensee's DID or other identifying information, age, residency, etc.) to the content provider for approval.

If the hosting platform determines to approve the transfer, the hosting platform may, at act 920, update access to the content. For instance, the hosting platform may revoke access previously granted to the current licensee (e.g., as described above in connection with act 815 in the example of FIG. 8), and may grant access to the new licensee (e.g., as described in connection with act 725 in the example of FIG. 7).

At act 925, the hosting platform may record, in the content registry, the revocation of the license previously granted to the current licensee (as described in connection with act 820 in the example of FIG. 8), and the license granted to the new licensee (e.g., as described in connection with act 730 in the example of FIG. 7).

While certain implementation details are described above in connection with the examples of FIGS. 8-9, it should be appreciated that such details are provided solely for purposes of illustration. In some embodiments, the content registry may be implemented using a distributed ledger, and a smart contract may be deployed on the distributed ledger to manage revocation and/or transfer of licenses. Additionally, or alternatively, licenses may be tokenized with transfer restrictions, which may allow creators to retain some form of control (e.g., ability to withhold consent to a proposed transfer).

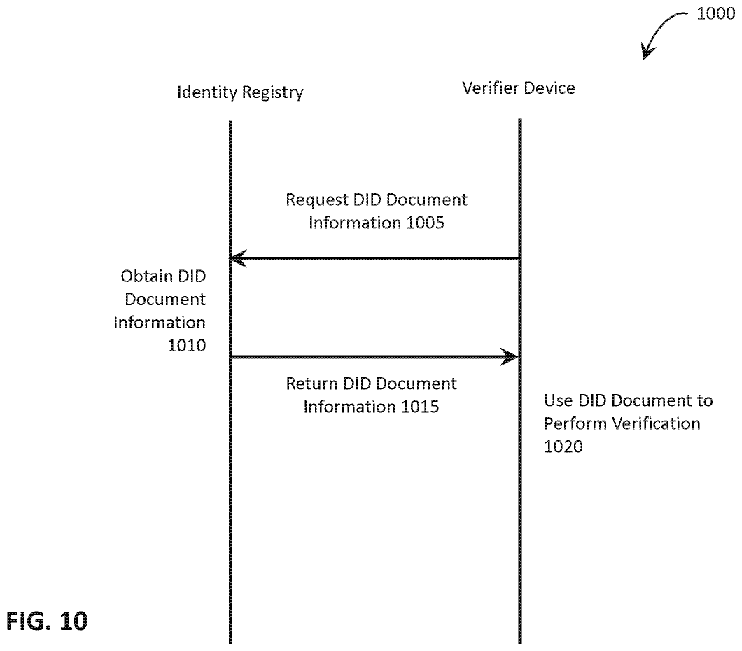

FIG. 10 shows an illustrative process 1000 for verification, in accordance with some embodiments. The process 1000 may be performed by a device of an entity performing a verification (hereafter referred to as the verifier) and/or an identity registry. The identity registry may be public, private, or permissioned, and may be implemented in any suitable manner, for example, using the illustrative distributed ledger 205 in the example of FIG. 2, a different distributed ledger, or a data store of some other type.

In some embodiments, the verifier may wish to verify integrity and/or authenticity of certain data. As an example, the verifier may be a content requester wishing to confirm that a piece of content received from a hosting platform is indeed generated by a certain content provider (e.g., as described in connection with the example of FIG. 5). As another example, the verifier may be a content storage wishing to confirm that a verifiable credential is indeed issued by a certain hosting platform (e.g., as described in connection with the example of FIG. 7).

Referring to the example of FIG. 10, the verifier device may, at act 1005, send a request to the identity registry. In some embodiments, the request may indicate a DID of an entity that is alleged to have signed the data to be verified (hereafter referred to as the DID owner). Additionally, or alternatively, the request may identify the DID owner in another way (e.g., by providing a name, a phone number, a physical address, an email address, a social media handle, a domain name, etc.), and the identity registry may be configured to match the request to a DID of the DID owner.

In response to the request of act 1005, the identity registry may, at act 1010, use the DID to obtain DID document information (e.g., by looking up a data store of DID document information). The DID document information may include a DID document associated with the DID, and/or information that may be used to resolve the DID into the DID document.

At act 1015, the identity registry may return the DID document information, and/or the DID itself, to the verifier device.

At act 1020, the verifier device may use the DID document information received at act 1015 to obtain a public key associated with the DID, and may use the public key to verify the signature purportedly generated by the DID owner over the data to be verified. If the signature is successfully verified, the data may be deemed trusted.

If the signature is not successfully verified, the verifier device may notify the verifier accordingly. Additionally, or alternatively, the verifier device may notify the DID owner. For instance, the DID document may indicate a communication method, such as a service endpoint for the DID owner in a peer-to-peer communication network. The verifier device may use the indicated communication method to notify the DID owner of a potential forgery.

Any suitable peer-to-peer communication network may be used, such as a network implementing a DIDComm Messaging specification provided by DIF. DIDComm Messaging provides a secure channel, so that the verifier device may communicate with the DID owner without exposing data to any centralized service. (By contrast, for example, communication via email may be subject to monitoring by an email service provider.) However, it should be appreciated that aspects of the present disclosure are not limited to using DIDComm Messaging, or any other peer-to-peer communication protocol.

While certain details of implementation are described above in connection with the example of FIG. 10, it should be appreciated that such details are provided solely for purposes of illustration. Aspects of the present disclosure are not limited to performing a verification in any particular manner, or at all. For instance, the DID may not be recorded in an identity registry. Instead, the verifier may obtain the corresponding DID document information directly from the DID owner (e.g., by scanning a QR code from a physical display, or by visiting the DID owner's web site), or from a trusted service (e.g., by providing another identifier of the DID owner, such as a name, a phone number, a physical address, an email address, a social media handle, a domain name, etc.).

Additionally, or alternatively, the DID owner may have multiple DIDs corresponding, respectively, to different contexts, where each context may include one or more counterparties. Such a DID is sometimes referred to herein as a peer DID.

A peer DID may be an N-wise DID or an anywise DID. A 2-wise DID is sometimes referred to herein as a pairwise DID. For instance, the DID owner may have multiple DIDs corresponding, respectively, to different verifiers. Such a DID may be issued, for example, by the DID owner when a verifier initiates an interaction with the DID owner.

The inventors have recognized and appreciated various benefits of using multiple DIDs. For example, if the DID owner uses the same DID in multiple contexts, the DID owner's activities in such contexts may be correlated. Having a separate DID for each context may impede such correlation. Furthermore, if the DID owner uses the same DID to interact with multiple verifiers, such interactions may be correlated to tie the verifiers to one another. Having a separate DID for each verifier may reduce such correlation.

However, it should be appreciated that aspects of the present disclosure are not limited to using any peer DID, or any DID at all.

The inventors have recognized and appreciated that some creators, such as individuals and small organizations, may not have sufficient resources to manage various aspects of content licensing (e.g., access authorization, access control, usage metering, etc.). Accordingly, in some embodiments, a creator may delegate authority over one or more pieces of content to another entity (e.g., a hosting platform), so that the other entity may manage licensing activities on behalf of the creator. Such an entity is sometimes referred to herein as an authorizer.

In some embodiments, one or more pieces of content managed by an authorizer may be kept in a content storage controlled by the authorizer. Accordingly, the authorizer may perform both access authorization and access control. For instance, in response to a request from a content requester for a selected piece of content, the authorizer may instruct the content requester to submit a payment and/or to attest to one or more requirements (e.g., age, residency, etc.). Upon receipt of the payment and/or the attestation, the authorizer may retrieve the requested content from the content storage, and may provide the content to the content requester.

However, the inventors have recognized and appreciated that a content provider may prefer to retain more control. For instance, a content provider may wish to revoke authorization previously given to an authorizer for one or more pieces of content. If the authorizer has possession of a copy of the content, it may be challenging for the content provider to ascertain that the authorizer will stop providing the content to content requesters.

Accordingly, in some embodiments, an authorizer may perform access authorization without performing access control. For instance, one or more pieces of content managed by the authorizer may be kept in an independent content storage. In response to a request from a content requester to access a selected piece of content, the authorizer may instruct the content requester to submit a payment and/or to attest to one or more requirements (e.g., age, residency, etc.). Upon receipt of the payment and/or the attestation, the authorizer may issue a proof of authorization to the content requester, which may be submitted by the content requester to the content storage where the requested content is kept. The content storage may verify the proof of authorization. If the verification is successful, the content storage may provide the content to the content requester.

In some embodiments, the independent content storage may be controlled by one or more content providers. For instance, each of a plurality of content providers may have a separate content store, and a federated storage scheme may be used to provide a uniform interface for accessing content from the plurality of content stores.

A content provider may maintain a content storage in any suitable manner. In some embodiments, the content storage may be maintained on one or more devices of the content provider. Additionally, or alternatively, the content storage may be maintained on a remote device (e.g., a cloud computing server) under the content provider's account.

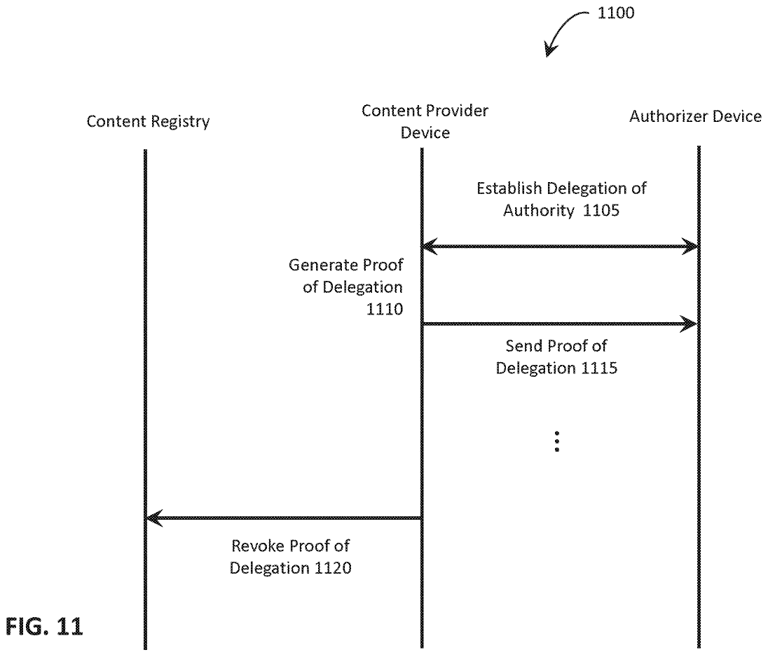

FIG. 11 shows an illustrative process 1100 for delegation of authority, in accordance with some embodiments. For instance, the process 1100 may be used by a provider of one or more pieces of content (e.g., the content provider 105 in the example of FIG. 1) to delegate authority to an authorizer.

In some embodiments, the authorizer may be the illustrative content management platform 100 in the example of FIG. 1, which may provide a marketplace through which users may list, search for, view, purchase, sell, and/or license content. However, it should be appreciated that aspects of the present disclosure are not so limited. In some embodiments, the authorizer may be separate from any marketplace.

Referring to the example of FIG. 11, the content provider may, at act 1105, interact with the authorizer to establish delegation of authority over the one or more pieces of content. For instance, a device of the content provider may send to a device of the authorizer identifying information for the content provider, such as a DID of the content provider. Likewise, the authorizer device may send to the content provider device identifying information for the authorizer, such as a DID of the authorizer.

Additionally, or alternatively, the content provider device may send to the authorizer device information regarding the one or more pieces of content. Any suitable information may be provided, such as a cryptographic hash of the one or more pieces of content, a CID that may be used to retrieve the one or more pieces of content from a content storage (not shown in FIG. 11), etc.

At act 1110, the content provider device may generate a proof of delegation, which may serve as evidence that the content provider has delegated authority over the one or more pieces of content to the authorizer. At act 1115, the content provider device may send the proof of delegation to the authorizer device.

The proof of delegation may be generated in any suitable manner. For instance, the proof of delegation may include information regarding the one or more pieces of content, which may be the same as, or different from, the information regarding the one or more pieces of content provided to the authorizer device at act 1105. Additionally, or alternatively, the proof of delegation may include identifying information for the authorizer, which may be the same as, or different from, the identifying information for the authorizer provided to the content provider device at act 1105.

In some embodiments, the proof of delegation may be signed using a private key of the content provider. For instance, the proof of delegation may be prepared according to a Verifiable Credential specification provided by DIF, and may be signed using a private key associated with the DID of the content provider.

The inventors have recognized and appreciated that the content provider may, at some future time, wish to revoke the proof of delegation given to the authorizer. For instance, the content provider may no longer wish to license the one or more pieces of content. Additionally, or alternatively, the content provider may be dissatisfied with the authorizer's management of the one or more pieces of content.

Accordingly, in some embodiments, a content registry may be provided, where the content provider may record a revocation. The content registry may be public, private, or permissioned, and may be implemented in any suitable manner, for example, using the illustrative distributed ledger 205 in the example of FIG. 2, a different distributed ledger, or a data store of some other type.

At act 1120, the content provider may revoke the proof of delegation, for example, by submitting a request to the content registry to record an identifier of the proof of delegation in a revocation list. The request may indicate the content provider's DID, and may be signed using the private key associated with the content provider's DID.

In some embodiments, the content registry may use the content provider's DID to query an identity registry (e.g., the illustrative identity registry in the example of FIG. 10), and may obtain a public key based on DID document information returned by the identity registry. The content registry may then use the public key to verify the signature on the request of act 1120. If the signature is successfully verified, the content registry may record the identifier of the proof of delegation in the revocation list.

However, it should be appreciated that aspects of the present disclosure are not limited to having a content registry or a revocation list. In some embodiments, a proof of delegation may indicate an expiry date, and the content provider may periodically decide whether to issue a new proof of delegation to the authorizer.

Additionally, or alternatively, the content provider may revoke the proof of delegation by notifying the authorizer and/or a content storage in which the one or more pieces of content are kept.

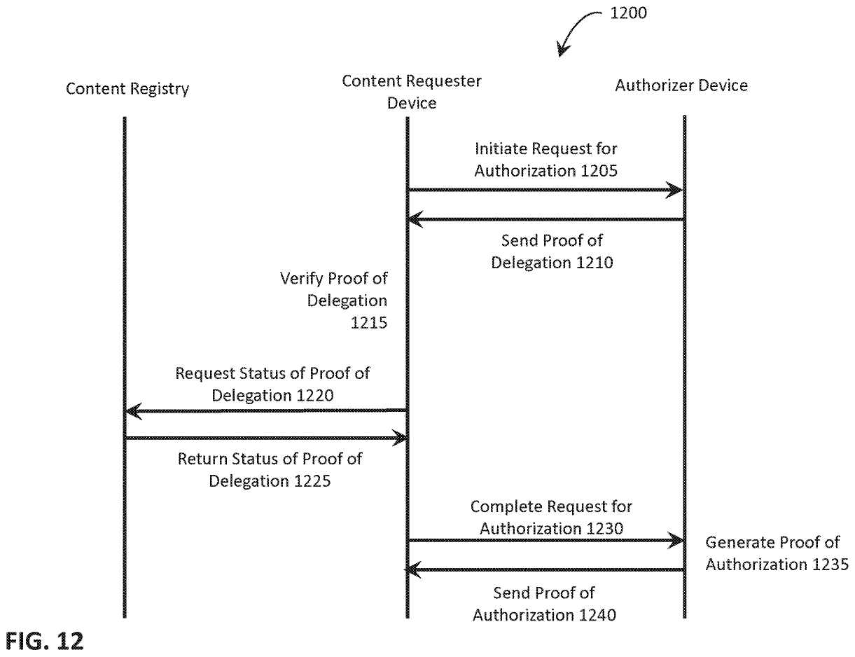

FIG. 12 shows an illustrative process 1200 for access authorization, in accordance with some embodiments. For instance, a content requester (e.g., the content requester 110 in the example of FIG. 1) may browse a marketplace (e.g., provided by the illustrative content management platform 100), and may decide to license a piece of content. A listing for the selected content may indicate that a provider of the content has delegated authority to an authorizer (e.g., the illustrative authorizer in the example of FIG. 11). Accordingly, the content requester may use the process 1200 to obtain, from the authorizer, authorization to access the content.

At act 1205, a device of the content requester may initiate a request for authorization with respect to the one or more pieces of content. The request may be sent to a device of the authorizer in any suitable manner.

For instance, the listing for the content may indicate a method for communicating with the authorizer, such as a link to the authorizer's web site, a link to download a software application configured to communicate with the authorizer device via a remote API, etc. The content requester device may use this communication method to initiate the request for the one or more pieces of content.

Additionally, or alternatively, the listing for the content may indicate a DID of the authorizer. The content requester device may use the authorizer's DID to query an identity registry (e.g., the illustrative identity registry in the example of FIG. 10). In response, the identity registry may return DID document information corresponding to the authorizer's DID. The DID document information may indicate a method for communicating with the authorizer, such as a service endpoint for the authorizer in a peer-to-peer communication network (e.g., a network implementing a DIDComm Messaging specification provided by DIF).

The request of act 1205 may include any suitable information regarding the one or more pieces of content, such as an identifier of the listing for the content, a cryptographic hash of the content, a CID that may be used to retrieve the content from a content storage (not shown in FIG. 12), etc.

At act 1210, the authorizer device may match the request of act 1205 to a proof of delegation for the one or more pieces of content, and may return the proof of delegation to the content requester device.

At act 1215, the content requester device may verify the proof of delegation. For instance, the proof of delegation may be signed using a private key associated with a DID of the content provider, and the listing for the content may indicate that DID. The content requester device may use that DID to query an identity registry (e.g., the illustrative identity registry in the example of FIG. 10). In response, the identity registry may return DID document information corresponding to the content provider's DID. The content requester device may then obtain a public key based on the DID document information, and may use the public key to verify the signature on the proof of delegation.

If the signature is successfully verified, the content requester device may proceed with the process 1200. Otherwise, the content requester device may halt the process 1200, and/or submit a report to the marketplace and/or the content provider.

As described above in connection with the example of FIG. 11, a content provider may, in some instances, revoke a proof of delegation previously given to an authorizer. Such revocation may be recorded in a content registry.

Accordingly, at act 1220, the content requester device may send, to the content registry, a status request for the proof of delegation. The request may indicate an identifier of the proof of delegation, which may be used by the content registry to look up a revocation list. At act 1225, the content registry may send a response to the request device, indicating whether the proof of delegation has been revoked.

If the proof of delegation has not been revoked, the content requester device may proceed with the process 1200. Otherwise, the content requester device may halt the process 1200, and/or submit a report to the marketplace and/or the content provider.

It should be appreciated that aspects of the present disclosure are not limited to having a content registry or a revocation list. In some embodiments, the proof of delegation may indicate an expiry date, and the content requester device may check whether the proof of delegation has expired.

At act 1230, the content requester device may complete the request for authorization with respect to the one or more pieces of content. For instance, the content requester device may submit a payment as instructed by the authorizer device. Additionally, or alternatively, the content requester device may provide information requested by the authorizer device. Any suitable information may be provided, such as identifying information (e.g., a DID) for the content requester, an attestation (e.g., for age, residency, etc.), etc.

Upon receiving the payment and/or the requested information, the authorizer device may, at act 1235, generate a proof of authorization, which may serve as evidence that the authorizer has given the content requester authorization to access the one or more pieces of content.

The proof of authorization may be generated in any suitable manner. For instance, the proof of authorization may include information regarding the one or more pieces of content, which may be the same as, or different from, the information regarding the one or more pieces of content included in the request initiated at act 1205. Additionally, or alternatively, the proof of authorization may include identifying information for the content requester, which may be the same as, or different from, the identifying information for the content requester provided to the authorizer at act 1230.

In some embodiments, the proof of authorization may be signed using a private key of the authorizer. For instance, the proof of authorization may be prepared according to a Verifiable Credential specification provided by DIF, and may be signed using a private key associated with the DID of the authorizer.

At act 1240, the authorizer device may send the proof of authorization to the content requester device.

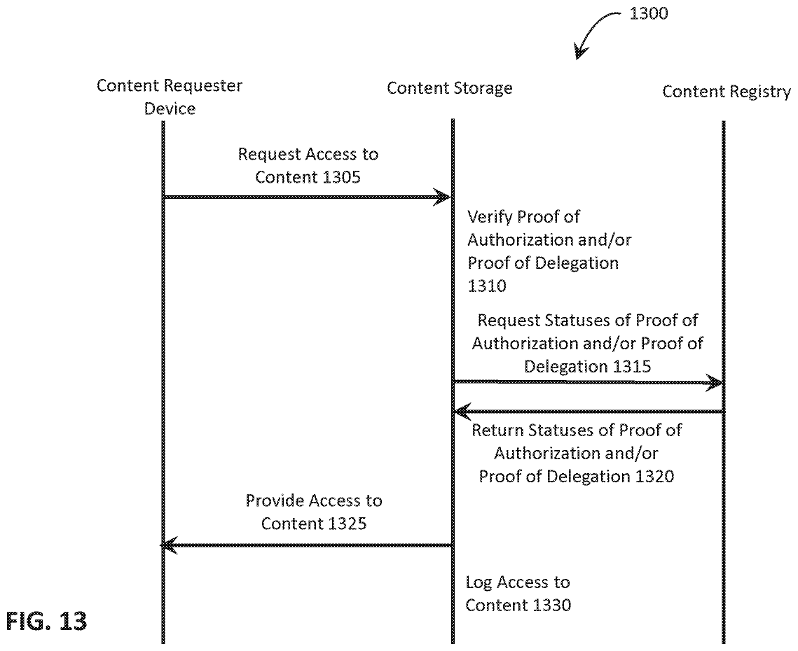

FIG. 13 shows an illustrative process 1300 for access control, in accordance with some embodiments. For instance, a content requester may use the illustrative process 1200 in the example of FIG. 12 to obtain a proof of authorization for one or more pieces of content. Thereafter, the content requester may use the process 1300 to present the proof of authorization to gain access to the one or more pieces of content.

As described in connection with the example of FIG. 12, a listing for the one or more pieces of content in a marketplace may indicate a content provider, an authorizer, and/or a content storage in which the one or more pieces of content are kept. Accordingly, the content requester may obtain the proof of authorization from the authorizer, and may present the proof of authorization to the content storage.

At act 1305, a device of the content requester may send an access request to the content storage. The request may include any suitable information regarding the one or more pieces of content, such as an identifier of the listing for the content, a cryptographic hash of the content, a CID, etc. Additionally, or alternatively, the request may include identifying information (e.g., one or more DIDs) for the content requester, the content provider, and/or the authorizer.

Additionally, or alternatively, the request may include the proof of authorization given by the authorizer to the content requester. Additionally, or alternatively, the request may include a proof of delegation given by the content provider to the authorizer (e.g., via the illustrative process 1100 in the example of FIG. 11). Such a proof of delegation may be provided to the content requester by the authorizer (e.g., via the illustrative process 1200 in the example of FIG. 12).

In some embodiments, the proof of authorization (signed by the authorizer) and/or the proof of delegation (signed by the content provider) may be assembled into a verifiable presentation by the content requester. The verifiable presentation may be prepared according to a Verifiable Credential specification provided by DIF, and may be signed using a private key associated with the DID of the content requester.

At act 1310, the content storage may verify the proof of authorization and/or the proof of delegation. For instance, the proof of authorization may be signed using a private key associated with the authorizer's DID. The content storage may use that DID to query an identity registry (e.g., the illustrative identity registry in the example of FIG. 11). In response, the identity registry may return DID document information corresponding to the authorizer's DID. The content storage may then obtain a public key based on the DID document information, and may use the public key to verify the signature on the proof of authorization.

Additionally, or alternatively, the proof of delegation may be signed using a private key associated with the content provider's DID. The content storage may use that DID to query an identity registry (e.g., the illustrative identity registry in the example of FIG. 11). In response, the identity registry may return DID document information corresponding to the content provider's DID. The content storage may then obtain a public key based on the DID document information, and may use the public key to verify the signature on the proof of delegation. Additionally, or alternatively, the content storage may confirm that the proof of delegation indeed identifies the authorizer (e.g., that the proof of delegation includes the authorizer's DID).

If the proof of authorization and the proof of delegation are successfully verified, the content storage may proceed with the process 1300. Otherwise, the content storage may halt the process 1300, and/or submit a report to the marketplace and/or the content provider.

As described in connection with the example of FIG. 11, a content provider may, in some instances, revoke a proof of delegation previously given to an authorizer. Similarly, an authorizer may, in some instances, revoke a proof of authorization previously given to a content requester. Such revocations may be recorded in a content registry.

Accordingly, at act 1315, the content storage may send, to the content registry, a status request for the proof of delegation and/or the proof of authorization. The request may indicate an identifier of the proof of delegation and/or an identifier of the proof of authorization, which may be used by the content registry to look up a revocation list. At act 1320, the content registry may send a response to the content storage, indicating whether either the proof of delegation or the proof of authorization has been revoked.

If neither the proof of delegation nor the proof of authorization has been revoked, the content storage may proceed with the process 1300. Otherwise, the content storage may deny the request to access the one or more pieces of content, and/or submit a report to the marketplace and/or the content provider.

It should be appreciated that aspects of the present disclosure are not limited to having a content registry or a revocation list. In some embodiments, the proof of delegation may indicate an expiry date, and the content requester device may check whether the proof of delegation has expired, and likewise for the proof of authorization.

Additionally, or alternatively, the content provider may revoke the proof of delegation by notifying the content storage, and the authorizer may revoke the proof of authorization in a like manner.

At act 1325, the content storage may provide the content requester with access to the one or more pieces of content. Such access may be provided in any suitable manner, for example, via an HTTP method such as GET or POST, or a streaming protocol such as HTTP Live Streaming (HLS) or Dynamic Adaptive Streaming over HTTP (DASH).

At act 1330, the content storage may log the content requester's access to the one or more pieces of content. For instance, audit data may be logged, such as the content requester's DID, the proof of delegation, the authorizer's DID, the proof of authorization, etc. Additionally, or alternatively, a time, a duration, and/or an amount of resource consumption may be logged, such as memory, processor cycles, network bandwidth, etc.

While certain implementation details are described above in connection with the examples of FIGS. 11-13, it should be appreciated that such details are provided solely for purposes of illustration.

Illustrative configurations of various aspects of the present disclosure are provided below.

Configuration A1. A computer-implemented method for recording content on an electronic ledger, the method comprising acts of: embedding a state of an electronic ledger into a piece of content, wherein the electronic ledger has recorded thereon a plurality of pieces of content; and recording the piece of content, with the state of the electronic ledger embedded therein, on the electronic ledger.

Configuration A2. The computer-implemented method of configuration A1, wherein: the electronic ledger is associated with an individual creator; and the plurality of pieces of content are generated by the individual creator.

Configuration A3. The computer-implemented method of configuration A1, wherein: the piece of content comprises visual content; and the piece of content with the state of the electronic ledger embedded therein is visually indistinguishable from the piece of content without the state of the electronic ledger embedded therein.

Configuration A4. The computer-implemented method of configuration A1, wherein: the state of the electronic ledger is embedded into the piece of content using a covert watermarking technique.

Configuration A5. The computer-implemented method of configuration A1, wherein: the state of the electronic ledger is embedded into the piece of content using a steganography technique.

Configuration A6. The computer-implemented method of configuration A1, wherein: the act of recording the piece of content on the electronic ledger comprises: storing a record on the electronic ledger, the record comprising a cryptographic hash of the piece of content with the state of the electronic ledger embedded therein.

Configuration A7. The computer-implemented method of configuration A1, wherein: the state of the electronic ledger embedded into the piece of content comprises a first state of the electronic ledger; and the method further comprises an act of: recording a second state of the electronic ledger on a distributed ledger.

Configuration A8. The computer-implemented method of configuration A7, wherein: the second state represents the electronic ledger after the piece of content has been recorded thereon.

Configuration A9. The computer-implemented method of configuration A1, wherein: the act of embedding a state of an electronic ledger into a piece of content further comprises embedding license information into the piece of content.

Configuration A10. The computer-implemented method of configuration A9, wherein: the license information indicates licensee identity, one or more permissions, and/or one or more restrictions.

Configuration B1. A computer-implemented method for managing a content registry, the method comprising an act of: recording an entry associated with an item of content, the entry comprising: (i) a content identifier (CID) of the item of content, (ii) a cryptographic proof for the item of content, and (iii) a decentralized identifier (DID) of a provider of the item of content, wherein: the cryptographic proof of the item of content is cryptographically signed using a private key associated with the DID of the provider of the item of content.

Configuration B2. The computer-implemented method of configuration B1, wherein: the entry associated with the item of content further comprises a DID of a content management platform on which the item of content is listed, the content management platform being separate from the content registry; and the DID of the content management platform is cryptographically signed using the private key associated with the DID of the provider of the item of content.

Configuration B3. The computer-implemented method of configuration B1, wherein: the entry associated with the item of content further comprises a DID of a content storage in which the item of content is stored, the content storage being separate from the content registry; and the DID of the content storage is cryptographically signed using the private key associated with the DID of the provider of the item of content.

Configuration B4. The computer-implemented method of configuration B1, wherein: the item of content comprises a first item of content; the entry associated with the item of content comprises a first entry; and the first entry further comprises a reference to a second entry associated with a second item of content, the second item of content being different from the first item of content.

Configuration B5. The computer-implemented method of configuration B4, wherein: the reference to the second entry indicates a relationship between the first item of content and the second item of content.

Configuration B6. The computer-implemented method of configuration B5, wherein: the relationship between the first item of content and the second item of content comprises a relationship selected from a group consisting of: updated version, adaptation, compilation, translation, excerpt, and summary.

Configuration B7. The computer-implemented method of configuration B4, wherein: the second entry comprises a DID of a provider of the second item of content, the provider of the second item of content being different from the provider of the first item of content.

Configuration B8. The computer-implemented method of configuration B1, wherein: the entry associated with the item of content comprises a first entry; and the method further comprises an act of: recording a second entry associated with the item of content, the second entry comprising: (i) the CID of the item of content, (ii) a DID of a content management platform on which the item of content is listed, the content management platform being separate from the content registry, and (iii) information relating to a license to the item of content, wherein: the information relating to the license to the item of content is cryptographically signed using a private key associated with the DID of the content management platform.

Configuration B9. The computer-implemented method of configuration B8, wherein: the information relating to the license to the item of content comprises an item selected from a group consisting of: an identifier of the license, a cryptographic proof for the item of content, a DID of an entity to which the license is granted, a license term, a permission, and a restriction.

Configuration C1. A computer-implemented method for providing access to content, the method comprising acts of: receiving an access request for an item of content, the access request comprising a proof of authorization by an authorizer, the proof of authorization purporting to authorize a content requester to access the item of content; verifying the proof of authorization, comprising using a public key associated with a decentralized identifier (DID) of the authorizer to verify a cryptographic signature on the proof of authorization; and in response to successfully verifying the proof of authorization, providing access to the item of content to the content requester.

Configuration C2. The computer-implemented method of configuration C1, wherein: the access request further comprises a proof of delegation by a provider of the item of content, the proof of delegation purporting to delegate authority to the authorizer; the method further comprises an act of: verifying the proof of delegation, comprising using a public key associated with a DID of the provider of the item of content to verify a cryptographic signature on the proof of delegation; and the access to the item of content is provided to the content requester in response to successfully verifying the proof of delegation.

Configuration C3. The computer-implemented method of configuration C2, wherein: the proof of authorization and the proof of delegation are assembled into a verifiable presentation; the method further comprises an act of: verifying the verifiable presentation, comprising using a public key associated with a DID of the content requester to verify a cryptographic signature on the verifiable presentation; and the access to the item of content is provided to the content requester in response to successfully verifying the verifiable presentation.

Configuration C4. The computer-implemented method of configuration C1, wherein: the method further comprises an act of: sending, to a content registry, a status request for the proof of authorization; and the access to the item of content is provided to the content requester in response to the content registry indicating that the proof of authorization has not been revoked.

Configuration C5. The computer-implemented method of configuration C2, wherein: the method further comprises an act of: sending, to a content registry, a status request for the proof of delegation; and the access to the item of content is provided to the content requester in response to the content registry indicating that the proof of delegation has not been revoked.

Configuration C6. The computer-implemented method of configuration C1, wherein: the method further comprises an act of: logging the access to the item of content, comprising logging: (i) a DID of the content requester and/or (ii) a time at which the access is provided to the content requester.

Configuration C7. The computer-implemented method of configuration C6, wherein: the act of logging the access to the item of content further comprises logging: (i) a duration of the access and/or (ii) an amount of a computing resource consumed in association with the access.

Configuration C8. The computer-implemented method of configuration C7, wherein: the computing resource is selected from a group consisting of: memory, processor cycles, and network bandwidth.

Configuration D1. A system comprising: at least one processor; and at least one computer-readable storage medium having stored thereon instructions which, when executed, program the at least one processor to perform the method according to any of configurations A1-A10, B1-B9, or C1-C8.

Configuration E1. At least one computer-readable storage medium having stored thereon instructions which, when executed, program at least one processor to perform the method according to any of configurations A1-A10, B1-B9, or C1-C8.

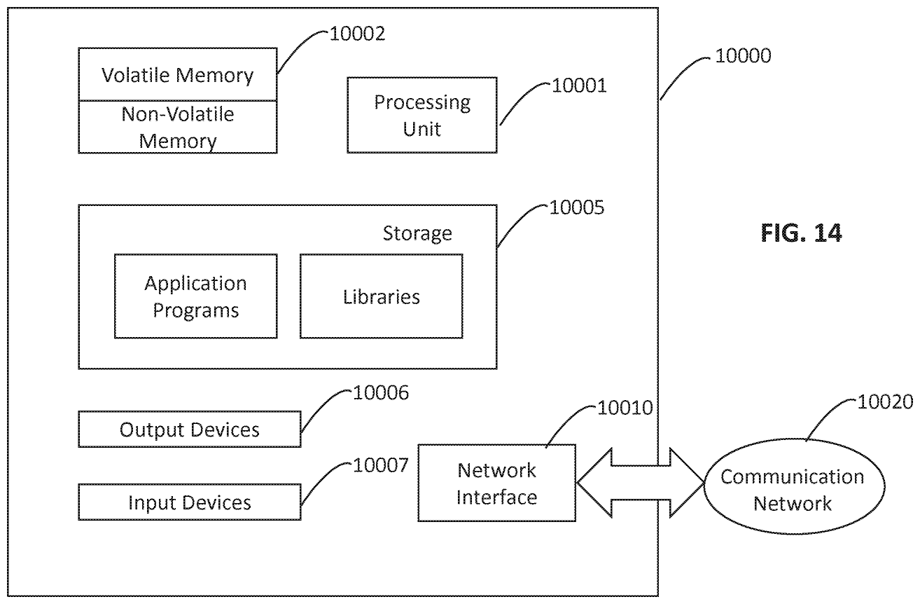

FIG. 14 shows, schematically, an illustrative computer 10000 on which any aspect of the present disclosure may be implemented.

In the example of FIG. 14, the computer 10000 includes a processing unit 10001 having one or more computer hardware processors and one or more articles of manufacture that comprise at least one non-transitory computer-readable medium (e.g., a memory 10002) that may include, for example, volatile and/or non-volatile memory. The memory 10002 may store one or more instructions to program the processing unit 10001 to perform any of the functions described herein. The computer 10000 may also include other types of non-transitory computer-readable media, such as a storage 10005 (e.g., one or more disk drives) in addition to the memory 10002. The storage 10005 may also store one or more application programs and/or resources used by application programs (e.g., software libraries), which may be loaded into the memory 10002. To perform any of the illustrative functionalities described herein, processing unit 10001 may execute one or more processor-executable instructions stored in the one or more non-transitory computer-readable media (e.g., the memory 10002, the storage 10005, etc.), which may serve as non-transitory computer-readable media storing processor-executable instructions for execution by the processing unit 10001.

The computer 10000 may have one or more input devices and/or output devices, such as devices 10006 and 10007 illustrated in FIG. 14. These devices may be used, for instance, to present a user interface. Examples of output devices that may be used to provide a user interface include printers, display screens, and other devices for visual output, speakers and other devices for audible output, braille displays and other devices for haptic output, etc. Examples of input devices that may be used for a user interface include keyboards, pointing devices (e.g., mice, touch pads, and digitizing tablets), microphones, etc. For instance, the input devices 10007 may include a microphone for capturing audio signals, and the output devices 10006 may include a display screen for visually rendering, and/or a speaker for audibly rendering, recognized text.

In the example of FIG. 14, the computer 10000 also includes one or more network interfaces (e.g., network interface 10010) to enable communication via various networks (e.g., network 10020). Examples of networks include local area networks (e.g., an enterprise network), wide area networks (e.g., the Internet), etc. Such networks may be based on any suitable technology operating according to any suitable protocol, and may include wireless networks and/or wired networks (e.g., fiber optic networks).

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing descriptions and drawings are by way of example only.

The above-described embodiments of the present disclosure can be implemented in any of numerous ways. For example, the embodiments may be implemented using hardware, software, or a combination thereof. When implemented in software, the software code may be executed on any suitable processor or collection of processors, whether provided in a single computer or distributed among multiple computers.

Also, the various methods or processes outlined herein may be coded as software that is executable on one or more processors running any one of a variety of operating systems or platforms. Such software may be written using any of a number of suitable programming languages and/or programming tools, including scripting languages and/or scripting tools. In some instances, such software may be compiled as executable machine language code or intermediate code that is executed on a framework or virtual machine. Additionally, or alternatively, such software may be interpreted.

The techniques disclosed herein may be embodied as a non-transitory computer-readable medium (or multiple non-transitory computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer-readable media) encoded with one or more programs that, when executed on one or more processors, perform methods that implement the various embodiments of the present disclosure described above. The computer-readable medium or media may be portable, such that the program or programs stored thereon may be loaded onto one or more different computers or other processors to implement various aspects of the present disclosure as described above.

The terms “program” or “software” are used herein to refer to any type of computer code or set of computer-executable instructions that may be employed to program one or more processors to implement various aspects of the present disclosure as described above. Moreover, it should be appreciated that according to one aspect of this embodiment, one or more computer programs that, when executed, perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Program modules may include routines, programs, objects, components, data structures, etc. that perform particular tasks or implement particular abstract data types. Functionalities of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields to locations in a computer-readable medium so that the locations convey how the fields are related. However, any suitable mechanism may be used to relate information in fields of a data structure, including through the use of pointers, tags, or other mechanisms that establish how the data elements are related.

Various features and aspects of the present disclosure may be used alone, in any combination of two or more, or in a variety of arrangements not specifically described in the foregoing, and are therefore not limited to the details and arrangement of components set forth in the foregoing description or illustrated in the drawings. For example, aspects described in one embodiment may be combined in any manner with aspects described in other embodiments.

Also, the techniques disclosed herein may be embodied as methods, of which examples have been provided. The acts performed as part of a method may be ordered in any suitable way. Accordingly, embodiments may be constructed in which acts are performed in an order different from illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” “based on,” “according to,” “encoding,” and variations thereof herein, is meant to encompass the items listed thereafter and equivalents thereof as well as additional items.

What is claimed is:

1. A computer-implemented method for recording content on an electronic ledger, the method comprising acts of:
embedding a state of an electronic ledger into a piece of content, wherein the electronic ledger has recorded thereon a plurality of pieces of content; and
recording the piece of content, with the state of the electronic ledger embedded therein, on the electronic ledger.

2. The computer-implemented method of claim 1, wherein:
the electronic ledger is associated with an individual creator; and
the plurality of pieces of content are generated by the individual creator.

3. The computer-implemented method of claim 1, wherein:
the piece of content comprises visual content; and
the piece of content with the state of the electronic ledger embedded therein is visually indistinguishable from the piece of content without the state of the electronic ledger embedded therein.

4. The computer-implemented method of claim 1, wherein:
the state of the electronic ledger is embedded into the piece of content using a covert watermarking technique.

5. The computer-implemented method of claim 1, wherein:
the state of the electronic ledger is embedded into the piece of content using a steganography technique.

6. The computer-implemented method of claim 1, wherein:
the act of recording the piece of content on the electronic ledger comprises:
storing a record on the electronic ledger, the record comprising a cryptographic hash of the piece of content with the state of the electronic ledger embedded therein.

7. The computer-implemented method of claim 1, wherein:
the state of the electronic ledger embedded into the piece of content comprises a first state of the electronic ledger; and
the method further comprises an act of:
recording a second state of the electronic ledger on a distributed ledger.

8. The computer-implemented method of claim 7, wherein:
the second state represents the electronic ledger after the piece of content has been recorded thereon.

9. The computer-implemented method of claim 1, wherein:
the act of embedding a state of an electronic ledger into a piece of content further comprises embedding license information into the piece of content.

10. The computer-implemented method of claim 9, wherein:
the license information indicates licensee identity, one or more permissions, and/or one or more restrictions.

11. A system comprising:
at least one processor; and
at least one computer-readable storage medium having stored thereon instructions which, when executed, program the at least one processor to perform a method for recording content on an electronic ledger, the method comprising acts of:
embedding a state of an electronic ledger into a piece of content, wherein the electronic ledger has recorded thereon a plurality of pieces of content; and
recording the piece of content, with the state of the electronic ledger embedded therein, on the electronic ledger.

12. The system of claim 11, wherein:
the electronic ledger is associated with an individual creator; and
the plurality of pieces of content are generated by the individual creator.

13. The system of claim 11, wherein:
the piece of content comprises visual content; and
the piece of content with the state of the electronic ledger embedded therein is visually indistinguishable from the piece of content without the state of the electronic ledger embedded therein.

14. The system of claim 11, wherein:
the state of the electronic ledger is embedded into the piece of content using a covert watermarking technique.

15. The system of claim 11, wherein:
the state of the electronic ledger is embedded into the piece of content using a steganography technique.

16. The system of claim 11, wherein:
the act of recording the piece of content on the electronic ledger comprises:
storing a record on the electronic ledger, the record comprising a cryptographic hash of the piece of content with the state of the electronic ledger embedded therein.

17. The system of claim 11, wherein:
the state of the electronic ledger embedded into the piece of content comprises a first state of the electronic ledger; and
the method further comprises an act of:
recording a second state of the electronic ledger on a distributed ledger.

18. The system of claim 17, wherein:
the second state represents the electronic ledger after the piece of content has been recorded thereon.

19. The system of claim 11, wherein:
the act of embedding a state of an electronic ledger into a piece of content further comprises embedding license information into the piece of content.

20. The system of claim 19, wherein:
the license information indicates licensee identity, one or more permissions, and/or one or more restrictions.

21. At least one computer-readable storage medium having stored thereon instructions which, when executed, program at least one processor to perform a method for recording content on an electronic ledger, the method comprising acts of:
embedding a state of an electronic ledger into a piece of content, wherein the electronic ledger has recorded thereon a plurality of pieces of content; and
recording the piece of content, with the state of the electronic ledger embedded therein, on the electronic ledger.
